(19) United States
(12) Patent Application Publication
(10) Pub. No.: US 2007/0103528 A1
(43) Pub. Date: May 10, 2007

(54) Ink composition

(75) Inventors: Yossi Pearl, Tel-Aviv (IL); Ofer Ben-Zur, RaAnana (IL)

Correspondence Address: Martin D. Moynihan;PRTSI, Inc., P.O. Box 16446, Arlington, VA, 22215, US

(73) Assignee: Kornit Digital Ltd., Moshav Magshimim (IL)

(21) Appl. No.: 11/606,154

(22) Filed: Nov. 30, 2006

Related U.S. Application Data
(63) Continuation-in-part of application No. PCT/IL05/00558, filed on May 30, 2005.
(63) Continuation-in-part of application No. PCT/IL05/00559, filed on May 30, 2005.
Application No. PCT/IL05/00558 is a continuation-in-part of application No. PCT/IL05/00166, filed on Feb. 10, 2005.
Application No. PCT/IL05/00559 is a continuation-in-part of application No. PCT/IL05/00166, filed on Feb. 10, 2005.
(63) Continuation-in-part of application No. 11/588,277, filed on Oct. 27, 2006.
Application No. 11/588,277 is a continuation-in-part of application No. 10/461,414, filed on Jun. 16, 2003, now Pat. No. 7,134,749.
(60) Provisional application No. 60/759,955, filed on Jan. 19, 2006.

(30) Foreign Application Priority Data
Aug. 11, 2004 (IL) 163459
May 30, 2004 (IL) 162231

(51) Int. Cl. B41J 2/01

(52) U.S. Cl. 347/101

(57) ABSTRACT

Novel ink compositions for printing durable, wash-fast and abrasion-fast images on surfaces, including such made of fibrous, porous or other absorptive materials, printing processes utilizing same and images formed thereby are disclosed.

### RELATED APPLICATIONS

This application is a Continuation-In-Part of PCT International Applications Nos. PCT/IL2005/000558 and PCT/IL2005/000559, both filed May 30, 2005, and both of which are Continuation-In-Part Applications of PCT International Application No. PCT/IL2005/000166, filed Feb. 10, 2005.

PCT International Applications Nos. PCT/IL2005/000558 and PCT/IL2005/000559 also claim the benefit of U.S. Provisional Patent Application No. 60/651,230, filed Feb. 10, 2005, and Israel Patent Applications Nos. 163459, filed Aug. 11, 2004 and 162231, filed May 30, 2004.

This Application also claims the benefit of U.S. Provisional Patent Application No. 60/759,955, filed Jan. 19, 2006.

This Application is also a Continuation-In-Part of U.S. patent application Ser. No. 11/588,277, filed Oct. 27, 2006, which is a Continuation-In-Part of U.S. patent application Ser. No. 10/461,414, filed Jun. 16, 2003, now U.S. Pat. No. 7,134,749. The teachings of all the above Applications are incorporated herein in their entirety.

### FIELD AND BACKGROUND OF THE INVENTION

The present invention relates to the field of printing and, more particularly, to a new ink composition and use thereof for high-resolution, high-definition multicolor direct printing on surfaces such as textile.

The ever growing market of printing complex designs and images on almost every type of surface, and especially on textile surfaces, creates demands for new and more versatile printing technologies and materials. One such demand is for an ink composition which will be suitable for printing long lasting, durable, abrasion resistant, water-, detergent- and chemical-fast color images on a variety of materials, which will not wear out rapidly upon use, handling, washing and exposure to the environment. The garment industry is possibly the most demanding in terms of printing high quality and durable prints of textile, adding some requirements from the product, such as pleasant hand-feel, flexibility and aerated print area.

To date, several technologies are typically used for printing on surfaces such as textile surfaces. These include, for example, mold block techniques such as rotogravure and flexographic printing, screen printing, dye sublimation and the most recent and promising inkjet printing, and especially digitally driven inkjet printing. However, the requirements set forth hereinabove are only partially met by these techniques, as is discussed in detail hereinbelow.

While some printing techniques can provide images that have some of the required features mentioned above, most of the presently known techniques do not provide images that have all these features. Thus, for example, using certain printing techniques that utilize polymerizable ink compositions oftentimes results in water-fast images which are too rigid and brittle or friable, tending to crack, and further have unpleasant hand-feel and are non-aerated. Other methods, which utilize water-based ink compositions, typically meet other requirements such as flexibility and pleasant hand-feel, but tend to fade rapidly and loose color definition upon exposure to the elements, contact with water, detergents and other chemicals and do not sustain reasonable use and wear of the subject material. Such unsatisfying results are also obtained by methods that utilize non-aqueous-based ink compositions. The presently known ink compositions used in the presently known printing technologies thus fail to comply with all of the abovementioned requirements at once.

As mentioned above, the most promising technology for printing high quality color images on a wide variety of types and shapes of substrates is inkjet printing. Inkjet printing is a wide-spread technique in which a stream of a specific liquid ink composition is ejected as droplets from minute nozzles to record characters and patterns on the surface of a printing subject without making direct contact between the ink application apparatus and the surface of the subject. A typical inkjet printing system includes methods and apparatus in which electric signals are converted to mechanical signals for a continuous or on-demand spraying of an ink composition which is stored in a nozzle head portion, to thereby record characters, symbols and patterns on the surface of a subject.

Inkjet printers have grown in availability, performance and popularity while dropping significantly in price, mostly due to their reliability, relatively quiet operation, versatility, graphics capability, print quality, and low cost. Moreover, inkjet printers have made possible “on demand” color printing without the need for complicated devices

Inkjet printers are capable of printing on a variety of surfaces. For example, commercial inkjet printers can spray directly on a non-flat, curved item such as the label on a glass bottle. For consumer use, there are a number of specialty papers, ranging from adhesive-backed labels or stickers to business cards and brochures.

When the subject surface is of a garment or another textile fabric surface, digital inkjet technology is probably the most favorable technique for designer art and image creation. It is relatively cheap and versatile, yet can provide high resolution multicolor photorealistic images, as many households experience with their low cost, high resolution inkjet home computer printers.

Reviews of various aspects of inkjet printing can be found in publications such as Kuhn et al., Scientific American, April, 1979, 162-178; Keeling, Phys. Technol., 12(5), 196-203 (1981); U.S. Pat. Nos. 3,060,429, 3,298,030, 3,373,437, 3,416,153, 3,673,601, 4,312,007 and 4,380,770; and numerous other publications.

The presently available ink compositions, including compositions that are suitable for inkjet printing, include aqueous-based ink compositions and non-aqueous solvent-based ink compositions. Aqueous-based ink compositions are typically composed of water and a colorant, usually a dye or pigment dispersion, and may further contain a number of additives for imparting certain features to the ink (e.g., improved stability and flow, feather resistance, and the like). Non-aqueous solvent-based ink compositions are typically composed of one or more volatile organic solvents, such as low alcohols, low alkanes and the like, a colorant and one or more additives which affect the physical and chemical properties of the composition.

The ink composition must ensure rapid drying, no bleeding or smearing, uniform printing on the surface of the subject, no blending of colors in the case of multicolor printing, wash-fastness, no clogging of the nozzles, easy system cleaning and other characteristics. To meet these requirements, the ink composition should be characterized, for example, by suitable viscosity, solubility, volatility, compatibility with other components of the printing system and, in cases of continuous flow inkjet printing, electrical resistance.

Thus, for example, for a “drop-on-demand” inkjet printer, the ink composition should typically have the following properties: room temperature Brookfield viscosity of 1 to 50 centipoises, surface tension of 25 to 55 dynes per centimeter and a submicron contained particle size.

For a continuous inkjet printer, the ink composition should typically have the following properties: room temperature Brookfield viscosity of up to 15 centipoises, electrical resistance of 50 to 2000 ohm per centimeter and a sonic velocity of 1200 to 1800 meters per second.

In particular, the ink composition must allow the colorant, being either pigment or dye, to adhere to the subject surface such that the resulting printed image is robust and has good adhesion to the subject surface, giving the printed image mechanical and chemical durability which ensures the image is wash-fast and abrasion resistant.

Unfortunately, however, applying the presently available ink compositions, while using any of the present printing techniques, including inkjet printing, on various surfaces, and particularly on more absorptive surfaces such as textiles, is associated with various limitations. The printed images are often neither water-fast nor detergent-resistant, resulting in fading of the printed image after washing, abrasion and/or exposure to various elements and further oftentimes fail to meet the demand for pleasant hand feel. Therefore, while the textile industry requires that the image be both water-resistant and detergent-resistant, that the colors and hues would be as vivid as possible, that the colorant of the ink would adhere tenaciously to the substrate, and that the desirable hand properties of the substrate would be maintained, the presently known ink compositions fail to accomplish these requirements.

Several techniques are presently known in the art which are aimed at overcoming the limitations associated with digital inkjet printing on textile and other absorptive surfaces. These include, for example, pre-treatment of the fabric prior to the printing process. Thus, U.S. Pat. Nos. 6,291,023, 6,698,874 and 6,840,992, for example, teach coating compositions which are applied on the fabric prior to printing. Albeit, these pre-treatments are not suitable for all fabric materials, use environmentally unfriendly chemicals, are time-consuming and cost-ineffective.

Partial answers to the abovementioned requirements of ink compositions were previously provided in the industry, and mostly involve curing the applied ink compositions by various levels of heat or by activating light-sensitive elements in the ink composition by UV illumination. In cases where such ink compositions are used, the curing results in the formation of cross-linking between the components of the ink composition. While such compositions may result in images that are chemically stable per se, these compositions fail to provide a printed image that is durable and long-lasting in terms of its interaction with the substrate.

For example, U.S. Pat. No. 4,978,969 discloses a method of inkjet printing using a UV curable ink composition. The ink contains a UV sensitive agent such as a urethane oligomer. The ink composition is applied onto the subject surface which is then exposed to UV light to effect the curing. A significant drawback of this method is that the aforesaid UV exposure is carried out for a relatively long period of time of about 0.5 to 10 minutes.

A heat curable system is disclosed in U.S. Pat. No. 5,230,733, which teaches an ink composition containing a water soluble polymer-bound dye, wherein the polymer has hydroxyl and carboxyl groups that can undergo a condensation reaction upon exposure to heat. The resulting polymer-dye conjugate is water-insoluble.

A two-component system is disclosed in U.S. Pat. No. 5,380,769. This system involves a base inkjet component containing a cross-linkable agent and a curing component containing a cross-linking agent. The components are applied onto the subject surface separately. An example of a cross-linkable agent according to this disclosure is an ethylene-acrylic acid copolymer, and an example of a cross-linking agent is an amine such as diethylenetriamine. The printed image contains the reaction product between the cross-linkable agent and the cross-linking agent.

European Patent Application 0672538 discloses an ink/support medium set. According to the teachings of this patent, the ink composition contains an aqueous carrier and a dye or pigment dispersion as the colorant. The support medium contains a plastic support sheet and a coating layer that contains a hydrophilic polymer, for example, polyvinyl alcohol, and a reactive component, for example, a compound that bears acid groups. After the inkjet printing, the printed medium is exposed to an energy source, such as heat or UV, and as a result, the hydrophilic polymer undergoes a cross-linking reaction.

Another two-part inkjet printing composition is disclosed in U.S. Pat. No. 4,694,302 wherein one part of the composition contains carboxymethylcellulose, which is a known reactive polymer, and the second part contains an aluminum salt. The dye, according to the teachings of this patent, can be present in either part. When the two parts are deposited on a subject surface, the reaction between the carboxymethylcellulose and the aluminum salt leads to the formation of a polymer lattice which binds the dye therein, thereby forming a water-fast ink. This patent also teaches a one-part ink composition wherein the ink contains a colloidal suspension of carbon black in diglyme solvent and a reactive species such as sebacyl chloride. Upon application on a cellulose-containing subject surface such as paper, the sebacyl chloride reacts with the cellulose to form a cellulosic polymer.

U.S. Pat. No. 6,140,391 discloses an ink composition containing alcohol(s), a polyol, an aldehyde-based cross-linking agent, an acid catalyst, a colorant and a carrier (solvent). According to the teachings of this patent, such a composition is particularly useful in the printing of identification marks on cellulose-based casings such as sausage casings. Thus, while cellulose-based substrates are typically characterized as relatively low-absorptive substrates, the suitability of this composition for printing on high absorptive surfaces such as textile is doubted. Further according to the teachings of this patent, the disclosed ink composition affords a highly cross-linked printed layer which in practice forms a film-type coating on the surface of the subject. As is well known in the art, such a film may become brittle and might crack after use, bending, stretching and other types of physical stress.

Other attempts aimed at achieving a high-quality, long-lasting image, involve protection of the image, once applied on the surface, by a protective coating, as taught, for example, in U.S. Pat. No. 6,626,530. These attempts, however, reduce the simplicity and cost-effectiveness of the process, while resulting in a final product with an unpleasant feel.

Hence, while the prior art teaches various ink compositions for printing images on various surfaces, these ink compositions are limited by poor performance of the images obtained thereby in terms of the image quality and durability, especially when applied on absorptive surfaces such as textile. Thus, the most commonly used ink compositions typically afford printed images which suffer from adverse characteristics such as sensitivity to abrasion, low wash-fastness, unpleasant hand-feel (and odor) of pre-treated fabrics and the unpleasant hand-feel and cracking of plasticized printed surfaces.

There is thus a widely recognized need for, and it would be highly advantageous to have, an ink composition which enables to produce high quality and durable images on absorptive surfaces in general and textile fabrics in particular, devoid of the above limitations.

### SUMMARY OF THE INVENTION

The color printing industry requires more flexible and versatile ink compositions which will be suitable for a variety of printing techniques, such as inkjet printing, onto a variety of substrates, such as textile fabrics and garments, which will afford high-quality yet durable, abrasion-fast image which will not deteriorate in washes, or be harsh to the touch and brittle.

Thus, according to one aspect of the present invention there is provided an ink composition suitable for printing an image on a substrate, which comprises a carrier, a colorant, an agent capable of chemically interacting with the substrate and a catalyst for promoting this interaction, the composition being substantially devoid of a polyol.

According to another aspect of the present invention there is provided an ink composition suitable for printing an image on a substrate, which comprises a carrier, a colorant, a polyol, an agent capable of chemically interacting with the substrate and a catalyst for promoting this interaction, with the proviso that the agent capable of chemically interacting with the substrate is not an aldehyde-based cross-linking agent.

According to yet another aspect of the present invention there is provided an ink composition suitable for printing an image on a substrate, which comprises a carrier, a colorant, a polyol, an agent capable of chemically interacting with the substrate and a catalyst for promoting this interaction, wherein a concentration of the polyol ranges from about 11 weight percentages to about 20 weight percentages of the total weight of the ink composition.

According to still another aspect of the present invention there is provided an ink composition suitable for printing an image on a substrate comprising a first part and a second part, wherein one of the first part or the second part comprises a property adjusting agent and the other part which does not comprise a property adjusting agent, comprises a property sensitive agent, and further wherein the first part comprises a carrier, a colorant and a polyol, and wherein the second part comprises a wetting composition which is capable of interfering with the engagement of the ink composition with at least one binding site on the surface of the substrate and said catalyst being for promoting said interacting.

According to yet an additional aspect of the present invention there is provided a process of printing an image on a substrate, the process includes applying any of the ink compositions described herein on the surface, so as to form the image on the substrate.

According to still an additional aspect of the present invention there is provided a process of printing an image on a substrate, the process includes providing the two parts ink composition described herein, contacting at least a portion of the surface of the substrate with the second part of the ink composition, so as to provide a wet portion of the surface; and applying the first part of the ink composition on the wet portion of the surface, so as to form the image on the substrate.

According to further features in preferred embodiments of the invention described below regarding the processes, the portion is a pre-determined portion of the surface.

According to further features in preferred embodiments of the invention described below regarding the process using the two parts ink composition, the density of the second part of the composition in the wet portion of the surface ranges from about 0.01 gram per 1 cm² to about 2 grams per 1 cm² of the wet portion of the surface.

According to further features in preferred embodiments of the invention described below regarding the process using the two parts ink composition, the property-adjusting agent effects a chemical and/or physical change in the property-sensitive agent upon contacting the first part and the second part, and thereby effects a chemical and/or physical change in the ink composition.

According to further features in preferred embodiments of the invention described below regarding the process using the two parts ink composition, the property is a chemical and/or physical property selected from the group consisting of acidity (pH), ionic strength, solubility, hydrophobicity and electric charge.

According to further features in preferred embodiments of the invention described below regarding the process using the two parts ink composition, the property-adjusting agent is selected from the group consisting of an acid, a base, a salt, a charged polymer, an oxidizing agent, a reducing agent, a radical-producing agent and a cross-linking agent.

According to further features in preferred embodiments of the invention described below regarding the process using the two parts ink composition, the property is acidity, and correspondingly the property-adjusting agent is an organic acid.

According to further features in preferred embodiments of the invention described below regarding the process using the two parts ink composition, the property-sensitive agent is selected from the group consisting of an adhesion promoting agent, a dispersing agent, a viscosity modifying agent, a thickener agent, a surface tension modifying agent, a surface active agent, a surfactant and a softener.

According to further features in preferred embodiments of the invention described below regarding the process using the two parts ink composition, the property-sensitive agent is an agent capable of chemically interacting with the surface and the property-adjusting agent is a catalyst.

According to still further features in the described preferred embodiments, the printing processes further includes, subsequent to the application of the ink composition, curing the image.

According to further features in preferred embodiments of the invention described below, the printing processes are effected digitally.

According to a further aspect of the present invention there is provided a substrate having an image printed thereon, prepared by the process using the single part ink composition of the present invention.

According to further features in preferred embodiments of the invention described below, the image is characterized by high durability, chemical-fastness and wash-fastness.

According to yet another aspect of the present invention there is provided a substrate having an image printed thereon, prepared by the process using the two parts ink composition of the present invention.

According to further features in preferred embodiments of the invention described below, the image is characterized by high color definition, high durability, chemical-fastness and wash-fastness.

According to further features in preferred embodiments of the invention described below, the chemical interaction with the substrate includes interacting with at least one functional group present within the substrate.

According to still further features in the described preferred embodiments the functional group is selected from the group consisting of an amine, an amide, a carboxyl, a hydroxyl and a thiol.

According to still further features in the described preferred embodiments the substrate is selected from the group consisting of a textile fabric, a paper, a wood and a plastic.

According to still further features in the described preferred embodiments the textile fabric is selected from the group consisting of wool, silk, cotton, linen, hemp, ramie, jute, acetate fabric, acrylic fabric, lastex, nylon, polyester, rayon, viscose, spandex, metallic composite, carbon or carbonized composite, and any combination thereof. Preferably the substrate is a garment made of a textile fabric, and more preferably the textile fabric is made of cotton.

According to still further features in the described preferred embodiments the printing is effected by inkjet printing.

According to still further features in the described preferred embodiments the ink composition is characterized by a Brookfield viscosity at room temperature that ranges from about 1 centipoise to about 150 centipoises.

According to still further features in the described preferred embodiments the ink composition has a surface tension that ranges from about 25 dynes per centimeter to about 55 dynes per centimeter.

According to further features in preferred embodiments of the invention described below, the ink composition has a maximal particle size lower than 1 micron.

According to still further features in the described preferred embodiments the ink composition has an electrical resistance that ranges from about 50 ohms per centimeter to about 2000 ohms per centimeter.

According to further features in preferred embodiments of the invention described below, the ink composition has a sonic velocity that ranges from about 1200 meters per second to about 1800 meters per second.

According to still further features in the described preferred embodiments the ink composition is characterized by a Brookfield viscosity at room temperature of about 16.5 centipoises, surface tension of about 31 dynes per centimeter and maximal particle size lower than 1 micron.

According to further features in preferred embodiments of the invention described below, the carrier is selected from the group consisting of an aqueous carrier and a non-aqueous carrier. More preferably, the carriers in each of the ink compositions described herein is an aqueous carriers comprising substantially water.

According to further features in preferred embodiments of the invention described below, the non-aqueous carrier is selected from the group consisting of a glycol ether, a glycol ether acetate, a ketone, an alkane, an alkene, a halogenated alkane, an alcohol, an aryl and any combination thereof.

According to still further features in the described preferred embodiments the concentration of the colorant ranges from about 0.1 weight percentages to about 40 weight percentages of the total weight of the ink composition.

According to still further features in the described preferred embodiments the agent capable of chemically interacting with the surface of the substrate is a cross-linking agent.

According to further features in preferred embodiments of the invention described below, the cross-linking agents is selected from the group consisting of an aldehyde-based cross-linking agent, a polyisocyanate based cross-linking agent, a silane based cross-linking agent, a peroxide based cross-linking agent, an ester based cross-linking agent, an amide based cross-linking agent and a vinyl based cross-linking agent.

According to still further features in the described preferred embodiments the aldehyde-based cross-linking agent is a modified melamine formaldehyde.

According to further features in preferred embodiments of the invention described below, the concentration of the agent capable of chemically interacting with the surface of the substrate ranges from about 0.1 weight percentages to about 60 weight percentages of the total weight of the ink composition.

According to still further features in the described preferred embodiments the catalyst is an acid. Preferably the acid is selected from the group consisting of dinonylnaphthalene sulfonic acid, dinonylnaphthalene disulfonic acid, dodecylbenzene sulfonic acid, toluene sulfonic acid, an alkyl phosphate acid and an aryl phosphate acid.

According to still further features in the described preferred embodiments the concentration of the catalyst ranges from about 0.01 weight percentages to about 15 weight percentages of the total weight of the ink composition. Preferably the concentration ranges from about 0.1 weight percentages to about 10 weight percentages of the total weight of the ink composition.

According to further features in preferred embodiments of the invention described below, the polyol is selected from the group consisting of a polyester polyol, a polyether polyol, a urethane polyol, a polyether, a polyester acrylate, an acrylic polyol, a urethane acrylic polyol, a polyester urethane triol resin, a polyvinyl butyral, a polyvinyl chloride acrylate and an oxidized castor oil.

According to still further features in the described preferred embodiments the concentration of the polyol ranges from about 0.5 weight percentages to about 30 weight percentages of the total weight of the ink composition.

According to further features in preferred embodiments of the invention described below, the ink composition further includes at least one additional ingredient selected from the group consisting of an amine stabilizer, an alcohol stabilizer, a non-reactive agent, a softener/plasticizer, a dispersing agent, a surface active agent and an ionizable material.

According to further features in preferred embodiments of the invention described below, the second part of the ink composition is characterized by a surface tension lower than a surface tension of the first part of the ink composition.

According to still further features in the described preferred embodiments the surface tension of the second part of the ink composition is lower than the surface tension of the first part of the ink composition by at least 2 dynes per centimeter. Preferably the second part of the ink composition is characterized by a surface tension lower than 50 dynes per centimeter. More preferably the surface tension of the second part of the ink composition ranges from about 35 dynes per centimeter to about 15 dynes per centimeter. Most preferably the surface tension of the second part of the ink composition ranges from about 25 dynes per centimeter to about 10 dynes per centimeter.

According to further features in preferred embodiments of the invention described below, the second part of the ink composition includes water.

According to further features in preferred embodiments of the invention described below, the second part of the ink composition includes at least one organic solvent.

According to still further features in the described preferred embodiments the organic solvent is selected from the group consisting of an alcohol, a ketone, an ether, an alkyl polysiloxane, an alkane, an alkene, a cycloalkane, a cycloalkene, an aryl, a heteroalicyclic, a heteroaryl and any combination thereof. Preferably the alcohol is selected from the group consisting of methanol, ethanol, propanol, 2-propanol, 1-butanol, 2-butanol and pentanol. Preferably the alkane is selected from the group consisting of hexane, heptane, octane, petroleum ether, tert-butylchloride, isobutylchloride, perfluorohexane, perfluoroheptane and perfluorooctane.

According to still further features in the described preferred embodiments the organic solvent has a boiling point lower than 100° C.

According to further features in preferred embodiments of the invention described below, the second part of the ink composition further includes at least one agent selected from the group consisting of an amine stabilizer, an alcohol stabilizer, a non-reactive agent, a softener/plasticizer, a surface active agent, a surface tension modifying agent, a viscosity modifying agent, a thickener agent and any combination thereof. Preferably, the concentration of any one of these agents ranges from about 0.01 weight percentages to about 75 weight percentages of the total weight of the wetting composition.

The present invention successfully addresses the shortcomings of the presently known configurations by providing novel ink compositions for printing durable, wash-fast and abrasion-fast images on surfaces, including such made of fibrous, porous or other absorptive materials.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

As used herein, the term “comprising” means that other steps and ingredients that do not affect the final result can be added. This term encompasses the terms “consisting of” and “consisting essentially of”.

The term “process” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

As used herein, the singular form “a,” “an,” and “the” include plural references unless the context clearly dictates otherwise. For example, the term “a compound” or “at least one compound” may include a plurality of compounds, including mixtures thereof.

Throughout this disclosure, various aspects of this invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 presents a photograph showing the back side of a 100% cotton garment onto which a colored image was directly printed (without applying a wetting composition), demonstrating the great extent of the ink penetration through the fabric; and

FIG. 2 presents a photograph showing the back side of a 100% cotton garment onto which a colored image was printed by contacting the cotton garment with a two parts ink composition wherein the second part is a wetting composition that comprises a property-adjusting agent, according to preferred embodiments of the present invention and thereafter printing the color image using the first part of the ink composition that comprises colorants and a property-sensitive agent, according to preferred embodiments of the present invention, demonstrating the limited penetration of the ink through the fabric that is advantageously effected by the use of the wetting composition.

### DESCRIPTION OF THE PREFERRED EMBODIMENTS

The present invention is of an ink composition suitable for printing images on a variety of substrates, particularly absorptive substrates such as textile, of printing processes utilizing same and of printed images formed thereby which are durable, wash-fast, chemically robust and resistant to physical wear.

The principles and operation of the ink composition, the process and the images according to the present invention may be better understood with reference to the accompanying descriptions and examples.

Before explaining at least one embodiment of the invention in detail, it is to be understood that the invention is not limited in its application to the details set forth in the following description or exemplified by the Examples. The invention is capable of other embodiments or of being practiced or carried out in various ways. Also, it is to be understood that the phraseology and terminology employed herein is for the purpose of description and should not be regarded as limiting.

As discussed in detail hereinabove, the presently available ink compositions, when utilized in various printing technologies, fail to provide an image which is characterized by the required quality and yet possess chemical and physical durability, mechanical flexibility and pleasant hand-feel. The absence of these characteristics is especially crucial in the garment industry where the printed substrates are absorptive and the printed image must sustain washes, stretching and other mechanical stress, abrasion and exposure to the elements.

While conceiving the present invention, it was envisioned that by utilizing an ink composition that includes a multifunctional component, which is capable of forming chemical bonds with functional groups that are naturally present in the substrate material, and available for binding on its surface, along with other components that can promote such a binding, the colorants in such a composition could be meshed into the printed substrate, and thus a highly durable image would be achieved. It was further envisioned that such an ink composition would be highly efficient for printing images on absorptive surfaces such as textile fabrics.

While reducing the present invention to practice, the present inventors have formulated several ink compositions, which are especially suitable for printing on textile fabrics, and which, when utilized in inkjet printing processes produce durable color images that exhibit resistance to water and other chemicals and yet are of high-quality and have a pleasant hand-feel.

Thus, each of the ink compositions of the present invention comprises, in addition to a colorant and a carrier (which functions as a solvent), an agent that is capable of chemically interacting with functional groups found within the printed substrate, preferably on its surface, as is detailed hereinbelow and a catalyst, which promotes such chemical interactions, as is further detailed hereinbelow.

Hence, according to one aspect of the present invention, there is provided an ink composition suitable for printing an image on a surface of a substrate, which includes a carrier, a colorant, an agent capable of chemically interacting with functional groups that are present within the printed substrate and a catalyst for promoting the chemical interaction. According to this aspect of the present invention, the composition is substantially devoid of a polyol.

According to another aspect of the present invention, there is provided an ink composition suitable for printing an image on a surface of a substrate, which includes a carrier, a colorant, a polyol, a non aldehyde-based cross-linking agent as the agent being capable of chemically interacting with functional groups present within the printed substrate and a catalyst for promoting the chemical interaction.

According to yet another aspect of the present invention there is provided an ink composition suitable for printing an image on a surface of a substrate, which includes a carrier, a colorant, a polyol, an agent capable of chemically interacting with functional groups present within the printed substrate and a catalyst for promoting the chemical interaction. According to this aspect, the concentration of the polyol ranges from about 11 weight percentages to about 20 weight percentages of the total weight of the ink composition.

The ink compositions, according to the present invention, are formulated so as to adhere to the substrate, preferably upon curing by heat. The curing is part of the printing process and can be effected by heat and/or dry air emanating from a heat source such as, for example, an infrared conveyor or a filament coil, or a dry air source such as, for example, a hot air blower.

The substrate, according to the present invention, can be any material onto which printing an image is desired, as long as the material contains functional groups that are available for interacting with the ink composition presented herein. Exemplary substrates include, without limitation, a textile fabric, a paper, a wood and a plastic. While the ink composition according to the present embodiments is designed to form durable images on absorptive substrates, preferably, the substrate is an absorptive material such as a textile fabric.

The textile fabrics, according to the present invention, may include wool, silk, cotton, linen, hemp, ramie, jute, acetate fabric, acrylic fabric, lastex, nylon, polyester, rayon, viscose, spandex, metallic composite, carbon or carbonized composite, and any combination thereof.

Preferably, the substrate onto which the image in printed on is a garment made of a textile fabric, and more preferably it is substantially comprised of cotton.

The ink composition, according to the present invention, is formulated such that is it suitable also for the main inkjet printing techniques, the “drop-on-demand” technique and the continuous flow techniques, as these techniques are familiar to any artisan skilled in the art. Therefore, preferably the ink composition of the present invention is for use in an inkjet printing machine.

Inkjet printing requires the ink composition to be characterized by several chemical and physical criteria, such as, Brookfield viscosity at room temperature, surface tension, maximal particle size, electrical resistance and sonic velocity, as these terms are known to any artisan skilled in the art. Each of the ink compositions presented herein therefore exhibits, among other properties, the following physical properties which render them suitable for inkjet printing:

Brookfield viscosity at room temperature that ranges from about 1 centipoise to about 150 centipoises; Surface tension that ranges from about 25 dynes per centimeter to about 55 dynes per centimeter; Maximal particle size lower than 1 micron; Electrical resistance that ranges from about 50 ohms per centimeter to about 2000 ohms per centimeter; and Sonic velocity that ranges from about 1200 meters per second to about 1800 meters per second. Preferably, the ink composition exhibits a Brookfield viscosity at room temperature of about 16.5 centipoises, a surface tension of about 31 dynes per centimeter and a maximal particle size lower than 1 micron.

The main components of the ink composition, according to the present invention, may vary according to the type of substrate and the specific requirements of the final printed product, yet each serve the same principle as follows. The carrier is selected to provide a medium for mixing, suspending and/or dissolving the other components of the ink composition, and be volatile and benign. The colorant is selected to achieve the desirable color and other physical and chemical properties, and be suitable for a given printing machine and printing technology. The agent which is capable of forming chemical interactions with the printed substrate is selected to be chemically compatible with the functional groups present within the substrate and preferably within its surface, such that it can form chemical bonds with these functional groups. Preferably, this agent is a cross-linking agent, as is detailed hereinbelow. The catalyst is selected to be chemically compatible with the agent above and the chemical interaction that occur with the substrate.

The term “colorant” as used herein describes a substance which imparts the desired color to the printed image. The colorant may be a pigment, a lake or a dye. Pigments are solid colorants with are typically suspended in the carrier of the ink composition, whereby dyes are liquid colorants which are dissolved in the carrier of the ink composition.

Apart for imparting the desired color to the printed image, the colorant is selected suitable in terms of its chemical and physical properties. Thus, for example, in a preferred embodiment of the present invention, the colorant is a heat curable colorant. Such colorants are preferred since, as is detailed hereinbelow, the chemical interaction between the agent that interacts with the substrate and the substrate is oftentimes heat-dependent and thus, an added value is obtained.

Exemplary dye colorants that are suitable for use in the context of the present invention include, without limitation, azo chrome complexes such as the commercially-available Orasol black RLI, Orasol Red G and CU phthalocyanine and similar azo-cobalt complexes. Exemplary pigment colorants that are suitable for use in the context of the present invention include, without limitation, quinacridone, benzimidazolone, carbon black, phthalocyanine, diarylide, azo, titanium oxide and calcium carbonate. Exemplary commercially available pigments are such as Permajet, Renol and Microlith.

Preferably, the colorant content in the ink composition of the present invention ranges from about 0.2 weight percentage to about 40 weight percentage of the total weight of the ink composition. More preferably, the colorant content ranges from 1 to 10 weight percentages of the total weight of the ink composition. One of the main components of the ink composition is the carrier. The carrier, according to the present invention, is required to be safe in terms of environmental hazards and volatile so as to allow fast drying and curing of the resulting image, and further be capable of dissolving and/or suspending all the other components of the ink composition so as to allow the ink composition to be applied easily and uniformly onto the substrate. The carrier affects the main physical properties of the ink composition, and thus is selected according to the required application and the other components. The carrier can be an aqueous carrier, having water as its main ingredient, or a non-aqueous carrier, having one or more organic solvents as its main ingredients.

The carrier content in the ink compositions presented herein typically ranges from about 20 weight percentages to about 90 weight percentages of the total weight of the ink composition.

As used herein the term “about” refers to +10%.

As used herein, the term “volatile” refers to a substance or a composition that is characterized by a relatively low boiling point and/or high evaporation rate.

Non-limiting examples of organic solvents which can compose the carrier include glycol ethers, glycol ether acetates, ketones, alkanes, alkenes, halogenated alkanes, alcohols, aryls and any combination thereof. Preferred organic solvents which can compose the carrier of the ink compositions presented herein include, without limitation, propylene glycol monomethyl ether acetate, 1-(1-methoxypropan-2-yloxy)propan-2-ol (dipropylene glycol monomethyl ether), 1-(1-(1-methoxypropan-2-yloxy)propan-2-yloxy)propan-2-ol (tripropylene glycol monomethyl ether), ethylene glycol butyl ether acetate, 4-methylpentan-2-one (methyl isobutyl ketone) and cyclohexanone.

According to the presently most preferred embodiment of the present invention, the carrier is an aqueous carrier, namely consisting essentially of water. Preferably the aqueous carrier further includes one or more organic solvents as described hereinabove.

As is discussed hereinabove, the component of the ink compositions presented herein, which provides for enhanced durability of the images formed thereby is an agent that is capable of chemically interacting with the substrate. Preferably, such agent interacts with functional groups that are present within the substrate material and more preferably, which are present on its surface.

As used herein, the phrase “chemical interaction” describes a chemical reaction which takes place between two or more substances, and typically leads to a formation of a bond. The bond, in the case of the present invention, can be a covalent bond, an ionic bond, a hydrogen bond and the like and thus, the chemical interaction can involve, for example, nucleophilic and electrophilic substitutions, nucleophilic and electrophilic addition reactions, elimination reactions, cycloaddition reactions, rearrangement reactions, chelate formation, ionic complex formation, affinity-pair formation and any other known organic and inorganic reactions.

As used herein, the phrase “functional group” describes a chemical moiety that is capable of undergoing a chemical reaction that typically leads to a bond formation. The bond, in the case of the present invention, can be a covalent bond, a ionic bond, a hydrogen bond and the like. Representative examples of suitable functional groups according to the present invention include, without limitation, amine, amide, halide, hydroxyl, thiol, cyano, sulfonamide, carboxyl, thiocarbamate, urea and thiourea, as these terms are defined hereinafter. Preferably, the functional groups according to the present invention are those which are abundant and available for chemical interactions in the substances which compose the substrate onto which the image in printed. Such functional groups that are present within prevalent substrates typically include, without limitation, amine, amide, carboxyl, hydroxyl and thiol.

By chemically interacting with the substrate, this agent provides for improves adherence of the ink composition and thus ensures that the image formed by the ink composition would sustain washes, abrasion and other physical and chemical stress. As mentioned hereinabove, according to a preferred embodiment of the present invention, the chemical interaction involves cross-linking and the agent capable of interacting with the substrate is a cross-linking agent.

As used herein, the term “cross-linking” describes a chemical reaction that involves the formation of interconnecting links between various components and thus leads to the cross-wise formation of interconnecting links. The phrase “cross-linking agent” as used herein thus refers to a chemical substance which has two or more reactive groups available for chemical interaction typically leading to bond formation, whereby these functional groups participate in such a bond formation that leads to cross-linking between other chemical substances. Preferably the cross-linking agent has more than two reactive groups, enabling the cross-linking agent to form a branched mesh of interconnecting links.

The reactive groups on the cross-linking agent according to the present invention must be chemically compatible with the functional groups available on the surface of the substrate, and be reactive under mild condition at which printing and/or curing are performed. For example, in the case of a substrate with amine groups on its surface, a cross-linking agent with a carboxyl groups may form amide bonds with the substrate. Similarly, hydroxyl and/or thiol groups on the surface of the substrate will form bonds with cross-linking agents having amine groups, carboxyl groups, acyl-halide groups, aldehyde groups, isocyanate groups, as these terms are defined hereinbelow, and many other such reactive groups which interact readily in mild conditions and/or mild heating.

Thus, the cross-linking agent can be, for example, an aldehyde-based cross-linking agent, an amine-based cross-linking agent, an isocyanate-based cross-linking agent, a carboxyl-based cross-linking agent, a silane based cross-linking agent, an acyl-halide cross-linking agent, a peroxide based cross-linking agent, an ester based cross-linking agent, an amide based cross-linking agent and a vinyl based cross-linking agent. Each of these cross-linking agents include one or more of the indicated reactive groups.

Aldehyde-based cross-linking agents are the most commonly used cross-linking agents in many industries due to their highly reactive profile under mild conditions and the relatively safe use thereof in industrial scale. When the ink composition is designed for printing onto textile fabrics, aldehyde-based cross linking agents are particularly advantageous due to the abundant presence of hydroxyl groups on surfaces of textile fabrics.

Therefore, unless otherwise indicated, in each of the aspects of the present invention, a preferred cross-linking agent is an aldehyde-based cross-linking agent

Still, aldehyde-based cross-linking agents may be found inadequate for certain applications. Thus, for example, aldehyde-based cross-linking agents can be chemically incompatible with other components in the ink composition, chemically incompatible with components in the substrate (such as a composite fiber fabric), and their use can be further limited by safety considerations, regulations and the likes. The high reactivity of aldehyde-based cross-linking agents may oftentimes lead to unstable ink composition, being difficult to prepare, store, transfer and utilize or having short shelf-life.

More important is the fact that aldehyde-based cross-linking agents typically form a highly cross-linked mesh which may be found too brittle for certain applications such as printing of fabrics and garments. Such an enhanced brittleness may lead to poor cracking-resistance of the formed image.

Hence, as is mentioned hereinabove and is further detailed hereinunder, while in some of the aspects of the present invention the agent capable of interacting with the substrate is a cross-linking agent, whereby the cross-linking agent is preferably an aldehyde-based cross-linking agent, in one aspect of the present invention, the agent capable of interacting with the substrate is not an aldehyde-based cross-linking agent. Ink compositions that include agents other than aldehyde-based cross-linking agents can be efficiently used in applications where reduced brittleness is desired. Such compositions may thus include other cross-linking agents, as described above.

As used herein, the term “amine” refers to an —NR′R″ group where R′ and R″ are each hydrogen, alkyl, alkenyl, cycloalkyl, aryl, heteroaryl (bonded through a ring carbon) or heteroalicyclic (bonded through a ring carbon) as defined hereinbelow.

The terms “alkyl” and “alkane” as used herein, describes a saturated aliphatic hydrocarbon including straight chain and branched chain groups. Preferably, the alkyl group has 1 to 20 carbon atoms. Whenever a numerical range; e.g., “1-20”, is stated herein, it implies that the group, in this case the alkyl group, may contain 1 carbon atom, 2 carbon atoms, 3 carbon atoms, etc., up to and including 20 carbon atoms. More preferably, the alkyl is a medium size alkyl having 1 to 10 carbon atoms. Most preferably, unless otherwise indicated, the alkyl is a lower alkyl having 1 to 5 carbon atoms.

The terms “alkenyl” and “alkene” refers to an alkyl group which consists of at least two carbon atoms and at least one carbon-carbon double bond.

The term “cycloalkyl” describes an all-carbon monocyclic or fused ring (i.e., rings which share an adjacent pair of carbon atoms) group where one or more of the rings does not have a completely conjugated pi-electron system. The term “heteroalicyclic” describes a monocyclic or fused ring group having in the ring(s) one or more atoms such as nitrogen, oxygen and sulfur. The rings may also have one or more double bonds. However, the rings do not have a completely conjugated pi-electron system.

The term “aryl” describes an all-carbon monocyclic or fused-ring polycyclic (i.e., rings which share adjacent pairs of carbon atoms) groups having a completely conjugated pi-electron system.

The term “heteroaryl” describes a monocyclic or fused ring (i.e., rings which share an adjacent pair of atoms) group having in the ring(s) one or more atoms, such as, for example, nitrogen, oxygen and sulfur and, in addition, having a completely conjugated pi-electron system. Examples, without limitation, of heteroaryl groups include pyrrole, furane, thiophene, imidazole, oxazole, thiazole, pyrazole, pyridine, pyrimidine, quinoline, isoquinoline and purine.

As used herein, the term “acyl-halide” describes a R′(C═O)X group wherein X is halide, as defined herein and R′ as defined herein.

The term “halide” describes fluorine, chlorine, bromine or iodine.

As used herein, the term “aldehyde” refers to a —C(═O)—H group.

As used herein, the term “amide” refers to both “C-amide” and “N-amide” whereas “C-amide” refers to a —C(═O)—NR′R″ group, where R′ and R″ are as defined herein and “N-amide” refers to an —NR′C(═O)—R″ group, where R′ and R″ are as defined herein.

As used herein, the term “carboxyl” refers to a —C(═O)OR′ group, where R′ is as defined herein.

The term “cyano” describes a —C—N group.

The term “hydroxyl” refers to a —OH group.

The term “isocyanate” describes an —N═C═O group.

The term “peroxide” refers to a —O—O—R′ group, where R′ is as defined herein.

The term “silane” describes a —O—Si—(OR′)(OR″)(OR′″) group, where R′, R″ and R′″ are as defined herein.

The term “sulfonamide” describes a —N—S(═O)₂—OR′ group, where R′ is as defined herein.

The term “thiocarbamate” describes a —O—(C═S)—NR′R″ group, where R′ and R″ are as defined herein.

The term “thiol” refers to a —SH group.

The term “thiourea” describes an —NR′—C(═S)—NR″R′″, with R′, R″ and R′″ as defined herein.

The term “urea” describes an —NR′C(═O)—NR″R′″, where R′, R″ and R′″ are as defined herein

As mentioned hereinabove, an aldehyde-based cross-linking agent is a preferred cross-linking agent in some aspects of the present invention. Exemplary types of aldehyde-based cross-linking agents include, without limitation, modified melamine formaldehyde based cross-linking agents, urea formaldehyde based cross-linking agents, glycoluril formaldehyde based cross-linking agents and benzoguanamine formaldehyde based cross-linking agents.

Exemplary modified melamine formaldehyde-based agents include, without limitation, methylated melamine formaldehyde, N-butylated melamine formaldehyde and isobutylated melamine formaldehyde. According to the present invention, a preferred modified melamine formaldehyde-based agent is a methylated melamine formaldehyde.

Exemplary urea formaldehyde based agent include, without limitation, methylated urea formaldehyde, N-butylated urea formaldehyde and isobutylated urea formaldehyde. Exemplary glycoluril formaldehyde based agents include, without limitation, N-butylated glycoluril formaldehyde and methylated/ethylated glycoluril formaldehyde. Exemplary benzoguanamine formaldehyde based agents include, without limitation, N-butylated benzoguanamine formaldehyde and methylated/ethylated benzoguanamine formaldehyde.

Preferably, the cross-linking agent content in the ink composition of the present invention ranges from about 0.4 weight percentage to about 55 weight percentage of the total weight of the ink composition. More preferably, the cross-linking agent content ranges from about 5 weight percentage to about 25 weight percentage of the total weight of the ink composition.

The ink compositions presented herein are typically designed such that the chemical interaction between the agent described above and the substrate would be effected in the presence of a catalyst.

The term “catalyst” as used herein describes a chemical substance which is capable of promoting, initiating and/or catalyzing the chemical reaction between the agent capable of chemically interacting with the substrate and the functional groups in the substrate. The catalyst is selected so to promote, initiate and/or catalyze the reaction upon contact of the ink composition with the substrate, optionally in combination with an external heat that is applied during the curing of the image.

The catalyst component of the ink composition of the present invention accelerates the chemical interaction between the substrate and the cross-linking agent such that a substantial portion of the functional groups and reactive groups in both the substrate and the agent will react therebetween during the time period that begins once the ink composition is applied onto the substrate and ends when the printed image is cured and the carrier has evaporated.

Preferred catalysts according to the present invention are acid catalysts and more preferred are strong acid catalysts. Acid catalysts are suitable since they may catalyze most of the reactions described above between various functional groups on the substrate and reactive groups within, e.g., the various cross-linking agents described above.

Since, when utilizing a highly reactive agent for interacting with the substrate, the presence of the catalyst may promote undesired reactions between the different components of the ink composition before its application onto the substrate, the acid catalyst is preferably attenuated. Thus, according to a preferred embodiment of the present invention, the acid catalyst is present in the ink composition either as a blocked catalyst, namely as a salt form thereof with a volatile basic counter-ion or as a complex with about 3 weight percentage of a low amine or about 15 weight percentage of a low alcohol present in the ink composition, whereby the amine or the alcohol serves as a volatile acid attenuating additive. The salt or the complex described above decompose upon application of the composition onto the substrate and thus the reactive form of the catalyst is generated.

Hence, according to a preferred embodiment of the present invention the catalyst is a blocked (salt) acid catalyst or an unblocked (free) acid catalyst. Exemplary blocked acid catalyst include, without limitation, blocked dinonylnaphthalene sulfonic acid, blocked dinonylnaphthalene disulfonic acid, blocked dodecylbenzene sulfonic acid, blocked toluene sulfonic acid, a blocked alkyl phosphate acid and a blocked aryl phosphate acid.

Preferably, the catalyst content in the ink composition of the present invention ranges from about 0.01 weight percentage to about 15 weight percentage of the total weight of the ink composition. More preferably, the catalyst content ranges from about 0.1 to about 10 weight percentages of the total weight of the ink composition.

As is further mentioned hereinabove, some of the ink compositions presented herein further include a polyol.

The term “polyol” describes a chemical substance that has two or more free hydroxyl groups, as this term is defined hereinbelow, and includes, for example, diols, a triols, tetraols, etc. Typical polyols are substances that include from about 50 to about 400 hydroxyl groups. Representative examples of a polyol include, without limitation, a polyester polyol, a polyether polyol, a urethane polyol, a polyester acrylate, an acrylic polyol, a urethane acrylic polyol, a polyester urethane triol resin, a polyvinyl butyral, a polyvinyl chloride acrylate and an oxidized castor oil.

The incorporation of polyols in the ink compositions of the present invention provides the formed image with chemical and physical qualities such as flexibility, softness and pleasant hand-feel. Without being bound to any specific theory, it is assumed that the polyol extends and branches the links which are formed between the functional groups on the surface of the substrate and the agent which is selected so as to interact therewith, and therefore affects the mesh affixing the colorant to the substrate. Nevertheless, while the enhanced flexibility of the resulting image, which results from the presence of polyol, may be advantageous is some applications, it may reduce the resistance of the formed image to chemical and physical stress and thus is disadvantageous in applications that require high resistance.

Therefore, while in some aspects of the present invention, the ink composition comprises a polyol, according to one aspect of the present invention, the ink composition is substantially devoid of polyol.

As used herein, the phrase “substantially devoid of” a certain substance refers to a composition that is totally devoid of this substance or includes no more than 0.1 weight percent of the substance.

Non-limiting examples of polyols that are suitable for use in the context of certain aspects of the present invention include ethylene glycol, diethylene glycol, triethylene glycol, polyethylene glycol, propylene glycol, dipropylene glycol, polypropylene glycol, butylene glycol, hexanediol, pentanediol, glycerin (glycerol), hexanetriol, and thioglycol.

Unless otherwise indicated, the polyol content in the ink composition of the present invention ranges from about 0.1 weight percentage to about 50 weight percentages of the total weight of the ink composition. Preferably, the polyol content in the ink composition ranges from 0.5 weight percentage to 30 weight percentages of the total weight of the ink composition and more preferably, the polyol content in the ink composition ranges from about 11 weight percentages to about 20 weight percentages of the total weight of the ink composition. A polyol content that ranges from about 11 weight percentages to about 20 weight percentages of the total weight of the ink composition is believed to be highly advantageous in terms of the formed image since it enables the provision of a flexible yet resistant image.

Hence, each of the ink compositions presented herein comprises a colorant, as is detailed hereinabove, a carrier, as is detailed hereinabove, an agent that is capable of chemically interacting with the substrate, as is detailed hereinabove, and a catalyst, as is detailed hereinabove.

As is mentioned hereinabove, in one embodiment of the present invention, the composition is devoid of a polyol. As discussed hereinabove, such compositions are highly suitable for printing applications in which highly stress-resistant images are desired. Such compositions, when including an aldehyde-based cross-linking agent, are further advantageous, since reactions that may occur in the ink composition before the application thereof, due to the high reactivity of both the aldehyde-based cross-linking agent and the polyol, are avoided and thus the stability of the ink composition prior to its application is enhanced.

In another embodiment, the ink composition further includes a polyol and the agent capable of interacting with the substrate is other than an aldehyde-based cross-linking agent. Such compositions are suitable for use in applications where reduced brittleness and enhanced flexibility of the formed image are desired. Such compositions are further characterized by improved stability prior to application, as is discussed hereinabove.

In still another embodiment, the ink composition includes a polyol in an amount that ranges from about 11 weight percentages and about 20 weight percentages. As is discussed hereinabove, such an amount provides for flexible yet stress-resistant image.

Each of the ink compositions described herein can further include one or more additional ingredient which may further modify the chemical and physical properties of the ink composition, and provide for improved performance of the formed image. Examples of such ingredients include, without limitation, non-reactive agents, softeners/plasticizers, dispersing agents, surface active agents and conductivity agents (ionizable materials).

Exemplary non-reactive agents include, without limitation, vinylchloride polymers, vinyl chloride-vinyl acetate copolymers and vinyl acetate polymers such as offered by Wacker Company, solid acrylics such as Paraloid DM55, Paraloid B-72 and B-82 such as offered by Rohm Haas Company and the like. The content of the non-reactive agent in the ink composition ranges from about 0.01 weight percentage to about 50 weight percentages of the total weight of the ink composition.

Exemplary softeners/plasticizers include, without limitation, an adipate ester, a phthalate ester, an aryl phosphate, a trimellitate ester and a plastisol, and many other commercially available softeners/plasticizers which are offered by such companies as ExxonMobil, Morflex and Byk-Chemie. The content of the softener/plasticizer ranges from about 0.01 weight percentage to 2.5 weight percentages of the total weight of the ink composition.

Exemplary dispersing agent include, without limitation, an acrylate polymer, an alkyl ammonium acidic polymer salt and other commercially available dispersing agents such as Byk 108 and Byk 180 offered by Byk-Chemie Company. The content of the dispersing agent ranges from about 0.01 weight percentage to about 10 weight percentages of the total weight of the ink composition.

Exemplary surface active agents include, without limitation, a soap, a detergent, a syndet, an emulsifier, a foaming agent, a polyalkylsiloxane, an anionic surface active agent, a cationic surface active agent and a non-ionic surface active agent. The content of the surface active agent ranges from about 0.01 weight percentage to about 5 weight percentages of the total weight of the ink composition. Exemplary ionizable materials include, without limitation, sodium chloride, potassium chloride, potassium bromide, calcium chloride, an alkali halide salt and an alkaline earth salt. The content of the ionizable material ranges from about 0.01 weight percentage to about 5 weight percentages of the total weight of the ink composition.

The requirement from any liquid ink composition to be fluid and cause ultimately no clogging in the fine fluid passages in the printing machine, and at the same time have the capacity to solidify and bind irreversibly to the material of the surface, put limits on compositions that can be used in inkjet machines. The balance between these requirements was considered by the present inventors whom hypothesized that the undesired compromise between fluidity and final durability requirements can be waived by using two fluid and cross-reactive agents that solidify or otherwise go through a chemical or physical change only upon contact therebetween.

While further searching for improved methodologies for printing an image on absorptive surfaces, the present inventors have found that by adding a property adjusting agent to either the liquid ink compositions or to the wetting composition and adding a property sensitive agent, which promotes the adhesion of the colorant to the substrate upon contacting the property adjusting agent, to any of the wetting or liquid ink compositions which do not have the property adjusting, result in affixing the colorants in the inks to the surface.

IL Patent Application No. 162231, a recently filed U.S. Provisional Patent Application No. 60/651,230 and WO 2005/15089, both by the present inventors and the present assignee and are incorporated by reference as if fully set forth herein, teach a process for printing an image on a substrate which is effected by wetting a surface onto which an image is to be printed with a wetting composition that interferes with the engagement of the liquid ink composition with the surface and thus temporarily modify the surface mechanical, physical and/or chemical characteristics, and thereafter forming an image by a typical printing process, on the wet surface. The process described in these patent applications results in high-resolution, high-definition and vivid images, with no bleeding and diffusion of the ink.

While further conceiving the present invention, the present inventors have thus envisioned that one or more of the components of the ink compositions presented herein may be added to the wetting composition which is applied onto the substrate prior to the application of the ink composition.

Thus, the ink composition can be made up of two parts, one that is applied onto the substrate prior to printing the image and one containing the colorant which is applied when printing the image. The two parts combine in situ on the surface of the substrate.

While further searching for improved methodologies for printing an image on absorptive surfaces, the present inventors have found that by adding a property adjusting agent to either the liquid ink composition or to the wetting composition and adding a property sensitive agent, which promotes the adhesion of the colorant to the substrate upon contacting the property adjusting agent, to any of the wetting or liquid ink compositions which do not have the property adjusting, result in affixing the colorants in the inks to the surface.

This feature can be effected according to the present invention since the image is formed by more than one pass over the surface, and since each part of the two-parts composition, namely the wetting composition and the liquid ink composition, can be applied by a separate mechanical element, such as a printing head or a spraying nozzle, a chemical/physical property-sensitive agent can be added to the one of the parts of the composition applied in one pass, and a chemical/physical property-adjusting agent, can be added to the other part of the composition applied in the other pass, thereby contacting these two agents when these two parts of the composition are applied onto the surface. The event of the contacting initiates a chemical reaction upon which the colorant of the two-part ink composition settles and is better affixed on the surface of the substrate.

Hence, according to an additional aspect of the present invention, there is provided an ink composition suitable for printing an image on a surface of a substrate which includes a first part and a second part, wherein the first part includes a carrier, a colorant, a polyol and a property sensitive agent, such as, for a non-limiting example, a cross-linking agent, and further wherein the second part includes a wetting composition and a property adjusting agent, whereby the wetting composition is capable of interfering with the engagement of the ink composition with at least one binding site of the surface of the substrate and the catalyst is as described hereinabove.

Alternatively, according to still an additional aspect of the present invention, the property adjusting agent is a component of the first part (the part containing the colorant), and the property sensitive agent is a component of the second part of the ink composition, being the wetting composition.

In general, the objective of using a property sensitive and adjusting agents is to provide the means to generate a chemical reaction between two agents which are reactive therebetween such that the reaction will occur only on the surface of the substrate and not beforehand. The property-adjusting agent is selected such that it effects a change in the property-sensitive agent only upon a contact therebetween, and thereby effects a chemical/physical change in the combined parts of the ink composition.

Preferably, the second part of the two-part ink composition includes the property-adjusting agent and the first part of the two-part ink composition includes the property-sensitive agent. Thus, upon contacting the first part with the second part during the printing process, the two-part ink composition undergoes a chemical change that prevents the penetration of the liquid ink into an absorptive substrate and at the same time enhances the adhesion of the colorant to the substrate.

The two parts ink compositions, according to these embodiments of the present invention, offer two fundamental advantages over that of presently known ink compositions, which are expressed in the final product having a color image printed on the substrate, namely a highly durable image which is wash-fast, chemical-fast, flexible and pleasant to the touch is obtained due to the unique capacity to chemically adhere to the substrate as a cross-linked mesh and an extraordinary high level of color definition of photorealistic qualities and no bleeding of the colors when applied on absorptive substrates such as textile fabrics, which is obtained due to the unique effect of the wetting composition which is applied onto the surface prior to the colorant. In addition, this two-part ink composition provides for improved stability of the ink composition prior to its use since the reactive components which may adversely react prior to its application, as is discussed hereinabove, are separated.

The term “property” as used herein refers to a chemical and/or physical property of the ink composition, namely, a characteristic of the composition that is reflected by the chemical composition and/or a physical parameter of the composition. Representative examples include, without limitation, acidity (pH), ionic strength, solubility, hydrophobicity, electric charge and the likes.

The term “pH” refers to the quantitative measure of the acidity or alkalinity (basicity) of liquid solutions, and translates the values of the concentration of the hydrogen ion which ordinarily ranges between about 1 and 10E-14 gram-equivalents per liter into the exponent negative values which range between 0 and 14.

The phrase “ionic strength” as used herein refers to the charge-weighted concentration of ions in solutions.

The term “hydrophobicity” as used herein refers to a quality of a non-polar molecule or group that has little affinity to water or other polar solvents. Hydrophobic groups on molecules in a polar solution tend to turn in on them or clump together with other hydrophobic groups.

The term “solubility” as used herein refers to the amount of a solute that will dissolve in a specific solvent under given conditions. The reduction of solubility may be effected by a change in another chemical property such as pH, ionic strength and hydrophobicity.

The phrase “property-sensitive agent” refers to a component of a composition which is sensitive to a change in a particular chemical and/or physical property of the composition and as a result of such a change undergoes a chemical and/or physical change which effects the entire composition.

The chemical or physical change that takes effect upon contacting these agents is preferably designed so as to afford better binding between the colorants and the substrate, and hence a preferred chemical and/or physical change can be, for example, solidification, adhesion, thickening, polymerization, sedimentation and cross-linking.

The action of thickening, sedimentation and subsequent solidification of one or more components in the ink composition promotes adhesion of the colorant to the substrate by, for example, direct chemical binding or entanglement of these components with functional groups in the substrate, as described hereinabove, upon polymerization and/or cross-linking thereof which is effected upon the abovementioned chemical or physical property change caused by the property-adjusting agent. For example, a property-sensitive cross-linking agent such as glutaraldehyde can become chemically reactive upon a change in the pH and interact with an amine-rich resin in the composition and form a semi-solid substance which adheres to the substrate as an entangled mesh, as well as directly via amine groups on the surface of the substrate. This reaction entraps particles of the colorant in the mesh thereby promoting the adhesion thereof to the material of the substrate.

The phrase “property-adjusting agent” as used herein refers to a component in one part of a two-parts composition and can effect the level of one or more chemical or physical property of the other part of the composition when the two part come in contact and combine, such as a pH level, the ionic strength, the hydrophobicity or the electric charge of the combined composition. By effecting a change in one or more such properties, the property-adjusting agent is causing the property-sensitive agent to undergo a chemical and/or physical change, as discussed hereinabove.

In particular embodiments, the catalyst, as presented hereinabove, can serve as the property adjusting agent, and the agent that is capable of chemically interacting with the substrate can serve as the property sensitive agent.

The abovementioned chemical properties can be readily adjusted by adding a chemical substance (the property-adjusting agent) which lowers or elevates the level of these properties. For example, adding an acid (H+ ions) will elevate the acidity while adding a base will lower the acidity level. Similarly adding a salt will elevate the ionic strength, adding a precipitating agent will lower the solubility, adding a hydrophilic agent will lower the hydrophobicity, adding a charged species will elevate the electric charge, and so on, each property can be lowered or elevated by use of a suitable adjusting agent.

Exemplary property-adjusting agents present in either parts of the two-parts ink composition, according to preferred embodiments, include acids and/or bases that adjust the pH property; salts that adjust the ionic strength and electrical charge; or oxidizing agents, reducing agents, radical-producing agents and cross-linking agents which change the chemical reactivity of certain chemical groups present in one or more components of the other part of the ink composition and thereby effect the solubility thereof by promoting cross-linking and/or polymerization of these components.

The concentration of the property-sensitive agent depends on its type and role in the liquid ink composition, namely if it is a main resin binder it will constitute up to 50% of the total weight of the composition and if it is a minor additive such as a dispersant, it will constitute up to 10% of the composition. Typically, the concentration of the property-sensitive agent ranges from about 0.5 weight percentages to about 50%, and more preferably 30% of the total weight of the composition comprising same.

The concentration of the property-adjusting agent should correspond adequately to the type and amount of the property-sensitive agent, and can range from about 0.5% to about 20% of the total weight of the composition.

The following describes a few representative and non-limiting examples, which present how the objective of using the property sensitive and adjusting agents is met:

An acid-base interaction can cause a resin that is soluble in a basic or neutral composition to precipitate once it comes in contact with an acid, whereupon such solidification leads to a sharp increase in the viscosity of the composition.

An acid-base interaction can cause an emulsion of a colorant and other components that can keep its low viscosity under basic conditions, to turn into a gel having a very high viscosity once it comes in contact with an acid. For example, adding polyvinyl alcohol with a low molecular weight to one part of the ink composition and adding borax (sodium tetra borate) to the other part of the composition will cause the formation of a gel upon contacting these two parts. A similar effect will be achieved when using calcium acetate and isopropanol.

A resin being soluble in an aqueous solution will precipitate once it comes in contact with calcium and/or aluminum ions, whereupon it will become a solid and will effect a sharp increase in the viscosity of the combined parts of the composition.

A salt (ionic) interaction between anions and cations such that cause an emulsion to break and to its components to precipitate. Preferred salts for effecting an increase on the ionic strength include calcium salts such as calcium chloride and calcium acetate, and aluminum salts such as aluminum chloride and aluminum sulfate, and any combination thereof.

A hydrophilic-hydrophobic interaction between various solvents and polymeric latex resin that causes the resin to swell and precipitate and effect an overall rise in the viscosity of the combined composition.

A preferred chemical property, according to the present invention, is acidity, the preferred chemical adjusting agent is an acid, and preferably the acid is an organic acid. Preferably, the organic acid is a carboxylic acid such as, for example, a carbonic acid, a formic acid, an acetic acid, a propionic acid, a butanoic acid, an α-hydroxy acid such as glycolic acid and lactic acid, a halogenated derivative thereof and any combination thereof, and most preferably the acid is acetic acid.

In order to improve the stability of colorants and pigments on the surface once applied (and optionally cured or otherwise dried), it is known in the art that adhesion promoting agents can be used to affix the pigments to the surface.

As discussed hereinabove, the liquid ink composition may include an agent capable of chemically interacting with functional groups present within the substrate, and a catalyst for catalyzing the chemical interaction. In terms of the property adjusting and the property sensitive agents, the agent capable of chemically interacting with functional groups present within the substrate is the property sensitive agent, and the catalyst for catalyzing the chemical interaction is the property adjusting agent, but as opposed of coexisting in one composition, these two agents are now separated, each is present only in one part of the two-parts ink composition.

According to the present invention the first part of the ink composition include an agent capable of chemically interacting with functional groups present within the substrate, for example, an adhesion promoting agent which is soluble when present in the ink composition and may also acts as a dispersing agent for the various colorants and pigments which are included in these ink compositions, but precipitates and/or solidifies when, for example, the pH of the media it is dissolved in drops below a certain pH level, therefore it is a pH-sensitive dispersion and adhesion promoting agent.

Correspondingly, according to the present embodiments, the second part of the ink composition includes a catalyst for catalyzing the chemical interaction, for example, a pH-adjusting agent, namely an acid, which upon contacting the two parts of the ink compositions, lowers the pH thereof and thereby lowers the pH of the media of the pH-sensitive dispersion and adhesion promoting agent, causing it to precipitate and solidify, hence affixing the colorants and pigments of the ink composition and affords a durable printed image which is wash-fast, chemically robust and resistant to physical wear.

Hence, the chemical/physical property-sensitive agent, which undergoes a chemical reaction or physical change as a result of contacting the chemical/physical property-adjusting agent, is preferably an adhesion promoting agent, a dispersing agent, a viscosity modifying agent, a thickener agent, a surface tension modifying agent, a surface active agent, a surfactant and a softener, which is one of the components of the two-parts ink compositions. Preferably the chemical/physical property-sensitive agent is an adhesion promoting agent.

Exemplary adhesion promoting agents include, without limitation, an acrylic polymer, a polyurethane emulsion, a polyurethane polymer, a polyether polymer, a polyester polymer, a polyacrylate polymer, a polyvinyl chloride polymer, a polyvinyl acetate polymer, a polyvinyl butyral polymer, an aminosilicon polymer and any combination thereof.

Thus, according to preferred embodiments, the first part of the ink composition is preferably an aqueous based ink composition which includes a polymer which serves as a dispersion agent and a pH-sensitive adhesion promoting agent which precipitates when it comes in contact with the second part of the composition which is preferably aqueous-based wetting composition, which preferably comprises an acid as a property-adjusting agent, when these parts are applied one after the other on the surface of the substrate.

Exemplary formulations of the second part (the wetting composition), according to preferred embodiments are based on the following percentage of content ranges:

Water as an aqueous-based wetting composition carrier 65-99%

A property sensitive agent 0-35%

or a property adjusting agent 0-10%

Other additives 0-5%

Surface active agent 0-0.5%

As discussed hereinabove, preferably the wetting composition comprises a property adjusting agent and the liquid ink composition comprises a property sensitive agent. Preferably, the property adjusting agent is volatile.

For example, the wetting composition can comprise water and a relatively small amount of an acid, acting as a pH adjusting agent. In these cases, the water content of the wetting composition preferably ranges from 90% to 99.9% and the organic acid content in the wetting composition ranges from 10% to 0.1% respectively to the water content. More preferably the water content is 99.5% and the acid content is 0.5% and the organic acid is a volatile organic acid such as formic acid or acetic acid.

Following the exemplary second part, an exemplary and corresponding formulation of the first part of the ink composition is based on the following percentage of content ranges:

Water 0-95%

Glycols 0-95%

Pigment/colorant 0-35%;

Resin binder or a polymeric dispersion 0-20%;

Resin/binder 0-50%

Dispersing agent 0-20%

Rheology modifier 0-10%

Organic solvent 0-5%

Additives (anti-foaming agents, leveling agents, surface active agents etc.) 0-2%

Property sensitive agent 0-50%

or a property adjusting agent 0-35%

The property sensitive agent can be present as a main resin/binder (content of up to 50%), or a secondary resin/binder (content of up to 20%), or as a dispersant (content ranging from 0 to 20% or up to 60% of the pigment/colorant), or as a resin binder or a polymeric dispersion (content ranging from 0 to 20%).

Preferably the first part of the ink composition is alkaline (basic) so as to maintain the sensitive adhesion promoting agent in its soluble form, and therefore the pH setting agent is a base.

One of the key limitations in applying a liquid ink on absorptive surfaces, such as those made of fibrous materials or porous materials, stems from the interaction of the liquid ink with the material once the ink is applied, and before the ink is fully cured and fastened to the fabric. As is well known to a skilled artisan, when ink droplets are absorbed into an absorptive material upon contacting the surface, the color dots begin to feather (bleed), spread out in an irregular fashion, and therefore cover a larger area than the intended area, thus producing a fuzzy image with dull colors and low definition. Hence, while the quality of the printed image depends on the degree of absorption of the ink in the material of the subject surface, it is well recognized that in order to achieve a high-resolution and high-definition multicolor image on absorptive surfaces (obtained, for example, by spraying the inks onto the fabric's surface), it is highly desirable that an applied ink droplet would stay as a tight, symmetrical dot once being in contact with the fabric, and until it is fully cured.

As is widely taught in IL Patent Application No. 162231, U.S. Provisional Patent Application No. 60/651,230 and WO 2005/115089, the wetting composition is selected capable of interfering with the engagement of the liquid ink composition with at least one binding site of the surface. Such an interference includes, for example, temporarily modifying a mechanical property of the surface by, for example, reducing the contact area between the part of the ink composition containing the colorant and the surface by, e.g., filling the pores in the surface or flattening perturbing objects such as stray fibers; temporarily modifying a physical property of the surface by, for example, reducing the surface tension formed between the surface and that part of the ink composition; and temporarily modifying a chemical property of the surface by, for example, engaging the binding sites of the surface by, e.g., interacting with functional groups on the surface, masking, neutralizing or inverting the charge of functional groups on the surface.

As used herein the phrase “binding site” describes any site of the surface that may interact, either mechanically or physically, with the ink composition. These include, for example, functional groups on the surface that may physically interact with compatible reactive groups present in the ink composition; functional groups on the surface that may form hydrophobic or hydrophilic interactions with compatible functional groups present in the ink composition; flattening perturbing objects such as stray fibers that can interfere with the uniform application of the ink composition on the surface; any dry area of the surface which may thermodynamically promote absorption of the liquid ink composition; and any area of the surface which due to too high or too low surface tension promotes minimization or maximization of surface area of the ink droplets on the surface.

As is further discussed in detail in IL Patent Application No. 162231, U.S. Provisional Patent Application No. 60/651,230 and WO 2005/115089, the effect of the difference in surface tension of the wetting composition with respect to that of the ink composition affects the quality of the image. It has been assumed that contacting the surface with a wetting composition renders the resulting wet surface temporarily less absorptive to the ink by reducing its surface tension. More specifically, it has been assumed that the interference with the engagement of the ink composition with the surface is at least partially affected by reducing the surface tension of the surface. Thus, it has been assumed that a wetting composition characterized by a low surface tension in general, and particularly with respect to the liquid part of the ink composition containing the colorant may interfere with the absorption of the ink into an absorptive surface such as a textile fabric. Therefore, it has been assumed that preferred wetting compositions are those which exhibit the required surface tension difference between a given liquid ink composition and the wetting composition.

Hence, according to a preferred embodiment of the present invention, the second part of the ink composition which includes a wetting composition, is characterized by a relatively low surface tension.

Preferably, the surface tension of the second part of the ink composition consisting of a wetting composition is lower than 50 dynes per centimeter. Further preferably, the surface tension of the second part of the ink composition ranges from about 35 dynes per centimeter to about 15 dynes per centimeter. More preferably, the surface tension of the second part of the ink composition ranges from about 25 dynes per centimeter to about 10 dynes per centimeter.

According to another preferred embodiment of the present invention, the second part of the ink composition consisting of a wetting composition and the first part of the ink composition containing the colorant are formulated such that the surface tension of the second part is lower that the surface tension of the first part of the ink composition. Preferably, the surface tension of the second part is lower than the surface tension of the first part by at least 2 dynes per centimeter, more preferably by at least 3 dynes per centimeter, more preferably by at least 5 dynes per centimeter and even more preferably by at least 10 dynes per centimeter.

According to a preferred embodiment of the present invention, the wetting composition includes one or more organic solvents.

Since, as is discussed hereinabove, the wetting composition is aimed at temporarily modify the mechanical, physical properties of the surface during the application of the colorant thereon, while not affecting other properties of the surface, it is highly desirable that at least a majority the wetting composition could be removed from the surface once the printing process is completed. One of the simplest routes of removing substances under these conditions is by evaporation. Therefore, preferred organic solvents are characterized as volatile.

As is well accepted in the art, boiling points below 100° C. are considered as relatively low boiling points. Hence, according to a preferred embodiment of the present invention, the organic solvent has a boiling point lower than 100° C. Such organic solvents can be easily removed once the printing process is completed, during, for example, the curing process, as described above, which involves application of heat or air blow onto the surface.

As is discussed hereinabove, since it is assumed that characteristics such as volatility and low surface tension improve the beneficial effect of the wetting composition, preferred organic solvents are those that exhibit such characteristics. Representative examples of such organic solvents include, without limitation, alkanes, alkenes, cycloalkanes, cycloalkanes and aryls, which are collectively referred to herein as hydrocarbons, alcohols, ketones, ethers, alkyl polysiloxanes, heteroalicyclics, heteroaryls and any combination thereof.

As used herein, the term “alcohol” describes a chemical substance that bears one or more hydroxyl groups. An alcohol can be represented by R—OH, wherein R is alkyl, a cycloalkyl, alkenyl, alkynyl, aryl, heteroaryl and the likes, as these terms are defined herein. However, this term further encompasses such groups which bear two or more hydroxyl groups. Such substances are also referred to hereinabove as polyols.

Non-limiting examples of alcohols that are suitable for use in the context of the present invention include methanol, ethanol, propanol, 2-propanol, 1-butanol, 2-butanol and pentanol. The presently most preferred alcohols are ethanol, 2-propanol (isopropyl alcohol, IPA) and 1-butanol.

The term “ketone” in the context of this aspect of the present invention describes a chemical substance that has one or more carbonyl groups. A ketone can be represented by R—(C═O)—R′ wherein R is as define herein, and R′ is as defined for R.

Non-limiting examples of ketones that are suitable for use in the context of the present invention include acetone, cyclopentanone, cyclohexanone, methyl ethyl ketone and pentan-3-one. The presently most preferred ketone is cyclohexanone.

The term “ether” describes a chemical substance having one or more alkoxy groups. The term “alkoxy” refers to an —OR group, wherein R is as described hereinabove, and thus an ether can be represented by R—O—R′, wherein R and R′ are each independently as define herein.

Non-limiting examples of ethers that are suitable for use in the context of the present invention include ethylene glycol butyl ether acetate, propyl methyl ether, methoxy propanol, diethyl ether, 1-methoxyhexane, 1-ethoxyhexane and 1-propoxypentane. The presently most preferred ethers are ethylene glycol butyl ether acetate and propyl methyl ether.

The phrase “alkyl polysiloxanes” describes a polymeric chemical substance having the general formula 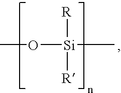
wherein n is an integer denoting the number of repeating polymeric units, and R and R′ are each independently as defined hereinabove. Preferably, n is an integer from 1 to 3.

Non-limiting examples of alkyl polysiloxanes that are suitable for use in the context of the present invention include dimethyl polysiloxane, ethyl methyl polysiloxane, phenyl methyl polysiloxane and nitrilobutyl phenyl polysiloxane. The most preferred alkyl polysiloxane is dimethyl polysiloxane.

The presently most preferred wetting compositions according to the present invention include one or more of the alcohols and hydrocarbons described hereinabove. The most preferred alcohols are methanol, ethanol, propanol, 2-propanol, 1-butanol, 2-butanol and pentanol, and the most preferred hydrocarbons are hexane, heptane, octane, petroleum ether, tert-butylchloride, isobutylchloride, perfluorohexane, perfluoroheptane and perfluorooctane.

The wetting composition may include, in addition to, or instead of, the organic solvent, water.

The second part of the ink composition consisting of a wetting composition according to the present invention may optionally further include one or more agents which may additionally alter the interaction of the first part of the ink composition with the surface and affect the chemical interaction between the components of the combined ink composition and the substrate. These include, without limitation, an amine stabilizer for the catalyst, an alcohol stabilizer for the cross-linking agent and the catalyst, a non-reactive agent, a softener/plasticizer, a surface active agent, a surface tension modifying agent, a viscosity modifying agent, a thickener agent and any combination thereof.

The addition of such agents to the second part of the ink composition may improve the effect of the wetting composition and may further provide a selected wetting composition with desirable characteristics. Thus, for example, the addition of surface tension modifying agents enables to use a wetting composition that comprises an organic solvent with moderate surface tension characteristics, which are improved by the added agent. The addition of viscosity modifying agents enables to use a wetting composition that comprises an organic solvent with high viscosity, which is reduced by the added agent, and so on.

The content of each of the abovementioned additives in the second part of the ink composition may range from about 0.01 weight percentage to about 75 weight percentage of the total weight of the wetting composition.

Using the ink compositions of the present invention in a printing process thus affords superior printing results, especially when printing on absorptive surfaces, which are characterized, in the cases of a single part ink composition, by durability and resistance to abrasions and other stresses, and in the case of the two parts ink composition, further characterized by high-quality, high-color definition and high-resolution photorealistic qualities, as well as improved stability and hence prolonged shelf-life.

Hence, according to another aspect of the present invention there is provided a process of printing an image on a surface of a substrate which using one of the single part ink compositions according to the present invention, and includes applying the ink composition on the surface, so as to form the image on the surface.

According to yet another aspect of the present invention there is provided a process of printing an image on a surface of a substrate using one of the two parts ink compositions of the present invention, and includes contacting at least a portion of the surface with the second part of the ink composition, so as to provide a wet portion of the surface; and subsequently applying the first part of the ink composition, containing the colorants on the wet portion of the surface, so as to form the image on the surface.

Contacting the surface with the second part of the ink composition can be further controlled by pre-determining the area of the surface that is to be wetted by the wetting composition, so as to contact with the wetting composition only that specific, pre-determined area of the surface onto which the image is printed in the subsequent stage of the process. The predetermination of the area to be wetted allows for optimization of the entire printing process which depends on accurate material quantification, i.e., of the two parts of the ink composition, and accurate timing of each printing steps, i.e., the wetting, the ink application and the curing steps. The pre-determination of the area of the surface can by readily established by a computerized algorithm. Hence, according to a preferred embodiment of the present invention, the part of the surface that is contacted with the wetting composition is pre-determined digitally.

Preferably, contacting the surface with the second part of the ink composition is performed so as to obtain a wet portion of the surface in which the density of the wetting composition ranges from about 0.01 gram per 1 cm² of the surface to about 2 grams per 1 cm² of the surface, more preferably from about 0.05 gram per 1 cm² to about 1 gram per 1 cm², more preferably from about 0.1 gram per 1 cm² to about 1 gram per 1 cm² and, more preferably, from about 0.2 grams per 1 cm² to about 0.6 grams per 1 cm².

Both processes, either the process using the single part ink composition and the process using the two parts ink composition, further include a curing step which may also affect the chemical interaction between the components of the ink composition and the removal of solvents from the carrier and the wetting composition as well as other volatile substances in the ink composition. The curing is effected by heat as described hereinabove.

The resulting image, according to the present invention is unique in the sense that it combines qualities which are absent or lacking in images which are printed by using presently known ink compositions and printing processes.

Therefore, according to another aspect of the present invention there is provided a substrate having an image printed on a surface thereon which is prepared by the printing process described hereinabove using a single part ink composition.

The image, according to this aspect of the present invention is characterized by an unusual and unique durability, resistance to mechanical, physical and chemical stresses, which is expressed by high wash-fastness, flexibility yet also with a pleasant hand-feel.

According to yet another aspect of the present invention there is provided a substrate having an image printed on a surface thereon which is prepared by the printing process described hereinabove which includes a wetting step, and using a two parts ink composition of the present invention.

The image, according to this aspect of the present invention is also characterized by an unusual and unique durability, resistance to mechanical, physical and chemical stresses, high wash-fastness, flexibility and a pleasant hand-feel, and further characterized by high color definition, high resolution photorealistic qualities, even when applied to absorptive surfaces such as textile fabrics.

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

### EXAMPLES

Reference is now made to the following examples, which together with the above descriptions; illustrate the invention in a non limiting fashion.

General Printing Procedure:

In all the Examples below, a “Kornit 930” or a “Kornit 931” digital printing machine (manufactured by Kornit Digital Ltd., Israel) and equipped with a wetting system for applying the wetting composition, as described hereinabove, were used.

Printing was typically performed on the surface of a 100% cotton textile T-shirt. Similar tests were also performed on a surface of 50% cotton and 50% polyester, yielding the same results.

The T-shirts were ironed for 5 seconds at 160° C. using an automatic press. Thereafter the ironed T-shirts were mounted on the digital printing machine.

The merits of the resulting multicolor image was assessed both qualitative (visually inspected) and quantitative (numerically parameterized). An exemplary multicolor image was printed for a qualitative assessment of the printing process and the resulting image. For a quantitative assessment of the printing process and the resulting image, four color squares (4×4 cm), each having one pure CMYK color were printed on the T-shirts without applying a wetting composition and compared to color squares printed with the wetting composition. The color squares were printed at 100% and 50% surface coverage on white T-shirts and 100% surface coverage on a black T-shirts. All prints were cured in an IR curing unit prior to testing.

Specifically, unless otherwise stated, the experimental preparations for printing on 100% cotton white T-shirts purchased from Anvil Ltd. included:

Machine type: KORNIT 931 D;

Printing resolutions of 727×727 dots per inch;

Wetting composition spraying rate of 0.08-0.014 grams per square centimeter;

Curing cycle: 160 sec at 160 C using a press; and for printing on 100% cotton black T-shirts (Beefy-T) purchased from Hanes included:

Machine type: KORNIT 931 D;

Printing resolution for two layers of opaque white ink composition at 636×454 dots per inch and one layer of water based CMY ink compositions at 636×454 dots per inch;

Wetting composition spraying rate of 0.025-0.032 grams per square centimeter;

Curing cycle: 160 sec at 160 C using a press.

Measuring Equipment:

Colorimeter/densitometer Eye-One (11) by Gretag Macbeth. Optical density measured using filter standard ANSI A (Internal auto calibration). Lab* (internal auto calibration) measured using observer angle 2 degrees and illumination set to D50.

Quantitative Assessment of Printing:

It is noted herein that there is a noticeable difference between the results as measured after conducting identical printing experiments using different textile pieces even when classified as similar, and even when coming from two different lots made by the same manufacturer. Namely, identical printing experiments using 100% cotton T-shirts of the same color including white, give varying results.

Nevertheless, the remarkable difference between prints with the use of a wetting composition and prints not using a wetting composition, always remain. In some textile types the amount of wetting composition and the optimal resolution at which the liquid ink composition can be applied may vary due to the fabric composition and nature, namely each textile type may require an adjustment for the optimal wetting amount and printing resolution. Using these optimized parameters will result in the most outstanding beneficial contribution of the wetting process.

An improved printing process on a textile piece achieves higher color intensity and brightness, namely high optical density, which can be translated into better coverage of a porous and non-uniform surface such as in the case of a textile piece.

In order to assess the quality of the resulting color prints using the process presented herein, L*a*b* parameters were measured.

As used herein, the term “L*a*b*” or “Lab*” refers to the CIE L*a*b* (International Commission on Illumination or Commission Internationale d'Eclairage, CIE) color model. Used interchangeably herein and throughout, CIE L*a*b*, L*a*b* or Lab is the most complete color model used conventionally to describe all the colors and shades which are typically visible to a normal human eye. The three parameters in the model define a particular color, whereas the lightness of the color is represented by the parameter L*, wherein L*=0 corresponds to black and L*=100 corresponds to white. The value between true magenta and true green is represented by the parameter a*, wherein a negative value indicates green and a positive value indicates magenta. The value between true yellow and true blue is represented by the parameter b*, wherein a negative value indicates blue and a positive value indicates yellow.

L*a*b* values which represent a three dimensional color space called calorimetric uniform color space as described in details hereinabove. In this color space model every set of three numbers (L*, a* and b*) represents one specific color that the human eye can perceive. The combination of all possible numbers (colors) affords the sum total (also known as the gamut) of the visual color range. Lab* values are used in the printing industry to quantify colors for evaluation of color differences (see, ΔE below), color gamuts, color transformations and other color qualities. The units of Lab* are absolute numbers.

Density, or optical density (OD) is a logarithmic scale of relative light reflectance from a defined surface. Optical density is used in the printing industry to measure quantities of ink deposits of printed materials. Since OD is determined with respect to a reference color, the units of OD are absolute numbers.

ΔE (pronounced “delta E”) is a measure of color difference between two colored objects which is calculated from their colorimetric values such as Lab*. The smaller the ΔE value, the closer the two colors are to one another visually.

Standard reference of C, M, Y and K colors are used to determine the colorimetric definition of tested colors in terms of Lab* values. These serve as standard benchmark for measuring, for example, inkjet printing quality.

The numeric difference in the optical density and Lab* values between multicolor images printed with and without wetting in an otherwise similar process were compared, measuring the front and the back side of the subject T-shirt.

### Example 1

A heat curable non-aqueous solvent-based blue dye ink composition suitable for a drop-on-demand inkjet printing machine according to the present invention, containing a carrier, a colorant, an aldehyde-based agent capable of chemically interacting with the target substrate to be printed, a catalyst for catalyzing this chemical interaction and other additives was prepared as follows:

Materials:

Propylene glycol monomethyl ether acetate (DOW Chemicals) 27.0 grams

Tripropylene glycol monomethyl ether (DOW Chemicals) 5.0 grams

Dipropylene glycol methyl ether (DOW Chemicals) 25.0 grams

BYK 315 (Byk-Chemie) 0.05 grams

BYK 051 (Byk-Chemie) 0.05 grams

Orasol Blue GL (Ciba) 4.9 grams

Modified melamine-formaldehyde resin (Cymel 325, Cytec Ind.) 35.0 grams

Blocked P-toluenesulfonic acid (Nacure 2501, King Ind.) 3.0

Preparation:

The listed chemicals were added to a glass vessel in the order of appearance, were shaken at 2100 rounds per minutes for 60 minutes at room temperature and the resulting mixture was filtered via a 1.6 micron glass fiber filter.

A 100% cotton fabric was mounted onto the machine, and an image was printed using the above described ink composition.

The printed fabric was then subjected to curing, by heating to 150-180° C. for 240 seconds using an infrared curing unit.

The resulting image exhibited a soft, flexible and non-cracking image having the desirable water-fast and chemical-fast properties.

### Example 2

A heat curable non-aqueous solvent-based black pigment ink composition suitable for a drop-on-demand inkjet printing machine according to the present invention, containing a carrier, a colorant, an aldehyde-based agent capable of chemically interacting with the target substrate to be printed, a catalyst for catalyzing this chemical interaction and other additives was prepared as follows:

Materials:

Dipropylene glycol methyl ether (DOW Chemicals) 58.0 grams

Tripropylene glycol monomethyl ether (DOW Chemicals) 4.0 grams

Cyclohexanone (Sigma-Aldrich) 9.5 grams

BYK 180 (Byk-Chemie) 0.5 grams

Renol Black R-HE 30 (Clariant) 4.0 grams

Modified melamine-formaldehyde resin (Cymel 1133, Cytec Ind.) 22.0 grams

Blocked P-toluenesulfonic acid (BYK 450, Bye-Chemie) 2.0

Preparation:

The ethers and cyclohexanone were added to a glass vessel and were mixed for 5 minutes. The other chemicals, except the acid catalyst and the Renol pigment were added and the resulting mixture was shaken for 10 minutes. The Renol pigment was added slowly while shaking at 2500 rounds per minute. After adding the pigment, the mixture was shaken at 6000 rounds per minute at room temperature for 90 minutes. The acid catalyst was then added and the resulting mixture was allowed to shake for another 10 minutes at 2000 rounds per minute and was thereafter filtered via a 1.6 micron glass fiber filter.

A 100% cotton fabric was mounted onto the machine, and an image was printed using the above described ink composition.

The printed fabric was then subjected to curing, by heating to 150-180° C. for 240 seconds using an infrared curing unit.

The resulting image exhibited a soft, flexible and non-cracking image having the desirable water-fast and chemical-fast properties.

### Example 3

A heat curable non-aqueous solvent-based black dye ink composition suitable for a drop-on-demand inkjet printing machine according to the present invention, containing a carrier, a colorant, an aldehyde-based agent capable of chemically interacting with the target substrate to be printed, a catalyst for catalyzing this chemical interaction and other additives was prepared as follows:

Materials:

Propylene glycol monomethyl ether acetate (DOW Chemicals) 50.0 grams

Tripropylene glycol monomethyl ether (DOW Chemicals) 5.5 grams

Cyclohexanone (Sigma-Aldrich) 14.9 grams

BYK 315 (Byk-Chemie) 0.05 grams

BYK 051 (Byk-Chemie) 0.05 grams

Orasol Black (Ciba) 5.0 grams

Modified melamine-formaldehyde resin (Cymel 325, Cytec Ind.) 23.0 grams

Blocked P-toluenesulfonic acid (Nacure 2501, King Ind.) 2.0

Preparation:

The listed chemicals were added to a glass vessel in the order of appearance, shaken at 2100 rounds per minutes for 60 minutes at room temperature and the resulting mixture was filtered via a 1.6 micron glass fiber filter.

A 100% cotton fabric was mounted onto the machine, and an image was printed using the above described ink composition.

The printed fabric was then subjected to curing, by heating to 150-180° C. for 240 seconds using an infrared curing unit.

The resulting image exhibited a soft, flexible and non-cracking image having the desirable water-fast and chemical-fast properties.

### Example 4

A heat curable non-aqueous solvent-based magenta pigment ink composition suitable for a drop-on-demand inkjet printing machine according to the present invention, containing a carrier, a colorant, an aldehyde-based agent capable of chemically interacting with the target substrate to be printed, a catalyst for catalyzing this chemical interaction and other additives was prepared as follows:

Materials:

Dipropylene glycol methyl ether (DOW Chemicals) 68.0 grams

Tripropylene glycol monomethyl ether (DOW Chemicals) 2.0 grams

Cyclohexanone (Sigma-Aldrich) 2.9 grams

BYK 315 (Byk-Chemie) 0.05 grams

BYK 051 (Byk-Chemie) 0.05 grams

Renol Blue B2G-HW 30 (Ciba) 4.0 grams

Modified melamine-formaldehyde resin (Cymel 1133, Cytec Ind.) 21.0 grams

Blocked P-toluenesulfonic acid (Nacure 2501, King Ind.) 2.0

Preparation:

The ethers and cyclohexanone were added to a glass vessel and mixed for 5 minutes. The other chemicals, except the acid catalyst and the Renol pigment were added and shaken for 10 minutes. The Renol pigment was added slowly while shaking at 2500 rounds per minute. After adding the pigment, the mixture was shaken at 6000 rounds per minute at room temperature for 90 minutes. The acid catalyst was then added and the resulting mixture was allowed to shake for another 10 minutes at 2000 rounds per minute and was thereafter filtered via a 1.6 micron glass fiber filter.

A 100% cotton fabric was mounted onto the machine, and an image was printed using the above described ink composition.

The printed fabric was then subjected to curing, by heating to 150-180° C. for 240 seconds using an infrared curing unit.

The resulting image exhibited a soft, flexible and non-cracking image having the desirable water-fast and chemical-fast properties.

### Example 5

A heat curable non-aqueous solvent-based red dye ink composition suitable for a drop-on-demand inkjet printing machine according to the present invention, containing a carrier, a colorant, an aldehyde-based agent capable of chemically interacting with the target substrate to be printed, a catalyst for catalyzing this chemical interaction and other additives was prepared as follows:

Materials:

The following heat-curable aqueous-based red dye ink composition suitable for a drop-on-demand inkjet printer was used:

Cymel 323 (Cytec Ind.) 29.5 grams

Distilled water 35.0 grams

Dipropylene glycol methyl ether (DOW Chemicals) 25.0 grams

BYK 033 (Byk-Chemie) 0.4 grams

BYK 024 (Byk-Chemie) 0.1 grams

Spectra fix Red 195 LIQ (Spectra) 8.0 grams

Blocked P-toluenesulfonic acid (Nacure 2501, King Ind.) 2.0

Preparation:

The listed chemicals were added to a glass vessel in the order of appearance, were shaken at 2100 rounds per minutes for 60 minutes at room temperature and the resulting mixture was filtered via a 1.6 micron glass fiber filter.

A 100% cotton fabric was mounted onto the machine, and an image was printed using the above described ink composition.

The printed fabric was then subjected to curing, by heating to 150-180° C. for 240 seconds using an infrared curing unit.

The resulting image exhibited a soft, flexible and non-cracking image having the desirable water-fast and chemical-fast properties.

### Example 6

A heat curable non-aqueous solvent-based ink composition suitable for a drop-on-demand inkjet printing machine according to the present invention, containing a carrier, a colorant, a polyol, an aldehyde-based agent capable of chemically interacting with the target substrate to be printed and a catalyst for catalyzing this chemical interaction is prepared as follows:

Materials:

(Amounts are given as weight percentage of total weight of the resulting ink composition)

Ethylene glycol butyl ether acetate (EGBEA) as a carrier, 55%

Microlith Black preparation as a colorant, 6%

Urethane Diol in propylene glycol mono-methylether acetate, 15%

N-butylated melamine formaldehyde for interacting with the subject chemically, 15%

Blocked p-toluenesulfonic acid as a catalyst, 3%

Phthalate ethyl ester, 2%

Polymethylsiloxane, 2%

Preparation:

The listed chemicals are added to a glass vessel in the order as listed and shaken at 2100 rounds per minutes for 60 minutes at room temperature and the resulting mixture is filtered via a 1.6 micron glass fiber filter.

The above ink composition is used to print an image on a 100% cotton fabric, and the printed fabric is subjected to curing, by heating to 150-180° C. for 240 seconds using an infrared curing unit.

### Example 7

A heat curable non-aqueous solvent-based ink composition suitable for a drop-on-demand inkjet printing machine according to the present invention, containing a carrier, a colorant, a polyol, a non-aldehyde-based agent capable of chemically interacting with the target substrate to be printed and a catalyst for catalyzing this chemical interaction is prepared as follows:

Materials:

(Amounts are given as weight percentage of total weight of the resulting ink composition)

Dipropylene glycol methyl ether as a carrier, 60%

Renol Black preparation as a colorant, 5%

Isocyanate-based cross-linking agent, 15% Polyester polyol, 10%

Blocked P-toluenesulfonic acid, 4%

Byk 108 as a dispersing agent, 2%

Polymethylsiloxane, 2%

Preparation:

The listed chemicals are added to a glass vessel in the order as listed and shaken at 2100 rounds per minutes for 60 minutes at room temperature and the resulting mixture is filtered via a 1.6 micron glass fiber filter.

The above ink composition is used to print an image on a 100% cotton fabric, and the printed fabric is subjected to curing, by heating to 150-180° C. for 240 seconds using an infrared curing unit.

### Example 8

A two parts heat curable non-aqueous solvent-based ink composition suitable for a drop-on-demand inkjet printing machine, according to the present invention, containing in the first part of the ink composition a carrier, a colorant, a polyol, and an aldehyde-based agent capable of chemically interacting with the target substrate to be printed, and further containing in the second part of the ink composition a wetting composition and a catalyst for catalyzing the chemical interaction between the aldehyde-based agent and the substrate, is prepared as follows:

Materials:

(Amounts are given as weight percentage of total weight of each part of the ink composition)

For the first part of the ink composition:

Ethylene glycol butyl ether acetate as a carrier, 60%

Propylene glycol monomethyl ether acetate as a carrier, 15%

Orasol dye as a colorant, 3%

Modified melamine-formaldehyde resin (such as Cymel 325), 11%

Polyester polyol (such as K-Flex XM-A307 by King Industries), 11%

For the second part of the ink composition:

Isopropyl alcohol 90%

Blocked p-toluenesulfonic acid, 10%

Preparation and Application:

The inkjet printing machine, according to this example, is equipped with a container for storing a wetting composition and a component which includes a spraying nozzle for applying the wetting composition on the substrate surface prior to the printing process.

The listed chemicals of the first part are added to a glass vessel in the order of appearance, shaken at 2100 rounds per minutes for 60 minutes at room temperature and the resulting mixture is filtered via a 1.6 micron glass fiber filter.

The listed chemicals of the second part are mixed and placed in the wetting composition container.

The spraying nozzle attached to the printing machine is used to uniformly apply the second part of the ink composition containing the wetting composition and the catalyst onto the subject surface.

Thereafter, the first part of the ink composition is used to print an image on the wetted 100% cotton fabric, and the printed fabric is subjected to curing, by heating to 150-180° C. for 240 seconds using an infrared curing unit.

### Example 9

For a quantitative assessment of the effect of the pre-wetting process using a two-parts aqueous-based ink composition, wherein the first part contains an exemplary property sensitive agent and the second part is an aqueous-based wetting composition which contains an exemplary property adjusting agent and.

As the first part, the following formulations of cyan, magenta, yellow and black colors (CMYK) were used.

Water as a carrier 30-40%

Commercially available colorants such as carbon black, quinacridone, phtalocyanine and diarylide (Ciba, DuPont and BASF) as a colorant 2-4%

Johncryl HPD 96 (an acrylic resin, Johnson) as a property (pH) sensitive agent and a dispersant 3-5%

Acronal S400 (acrylic emulsion, BASF) as an adhesion promoting agent 25-30%

Propylene glycol or diethylene glycol as humectant 20-30%

Triethanol amine or diethanol amine as an organic base 0.5-1%

Sodium lauryl sulfate as a surface active agent 0.1-0.5%

Modified siloxanes (BYK) as a defoamer 0.1-0.5%

A 100% white cotton T-shirt by Anvil was heat pressed for 3 seconds at 160° C. and mounted onto the machine (Komit 931 D).

An image composed of three rows of four squares of 4×4 cm of each color (CMYK) were printed on the media at 727×727 dots per inch in 100% coverage (first row), 75% coverage (second row) and 50% coverage (third row) of the surface per the given area and resolution.

The same color image was printed again on the same media after pre-wetting the predetermined area with a wetting composition in an amount of 0.008-0.014 grams per square centimeter:

Water as a wetting composition carrier 96.9%

Acetic acid (or formic acid or propionic acid) as a property (pH) adjusting agent 3%

Sodium lauryl sulfate as a surface active agent 0.1%

After printing the color image, the printed images were cured for 150 seconds at 150° C. using a heat press.

The optical density (OD) and Lab* values were measured on both side of the printed media, namely in the front and rear side of the fabric, using a colorimeter/densitometer Eye-One (II) by Gretag Macbeth, used as described hereinabove.

The results are presented in Table 1 below. The left column presents the percent of area coverage by the first part of the ink composition at a printing coverage (100%=727×727 dots per inch), indicating whether a wetting composition was used or absent.

TABLE 1

| Percent coverage | Cyan | Magenta | Yellow | Black |
|---|---|---|---|---|
| | Optical density on the front of the fabric | | | |
| 100% with wetting | 1.50 | 1.40 | 1.32 | 1.52 |
| 50% with wetting | 1.42 | 1.35 | 1.25 | 1.45 |
| 100% no wetting | 1.25 | 1.17 | 1.10 | 1.29 |
| 50% no wetting | 1.20 | 1.10 | 1.00 | 1.20 |
| | Optical density on the back of the above prints | | | |
| 100% with wetting | 0.20 | 0.22 | 0.16 | 0.25 |
| 50% with wetting | 0.15 | 0.16 | 0.12 | 0.20 |
| 100% no wetting | 0.44 | 0.47 | 0.42 | 0.50 |
| 50% no wetting | 0.30 | 0.29 | 0.27 | 0.35 |

As can be seen in Table 1, printing a colored image using the pre-wetting process yielded an optical density, corresponding to each basic color, which is overall greater on the front side of the fabric as compared to the images which were printed without using a wetting composition. As can further be seen in Table 1, the back side of the fabric was remarkably less stain with the colored ink composition when using the wetting composition.

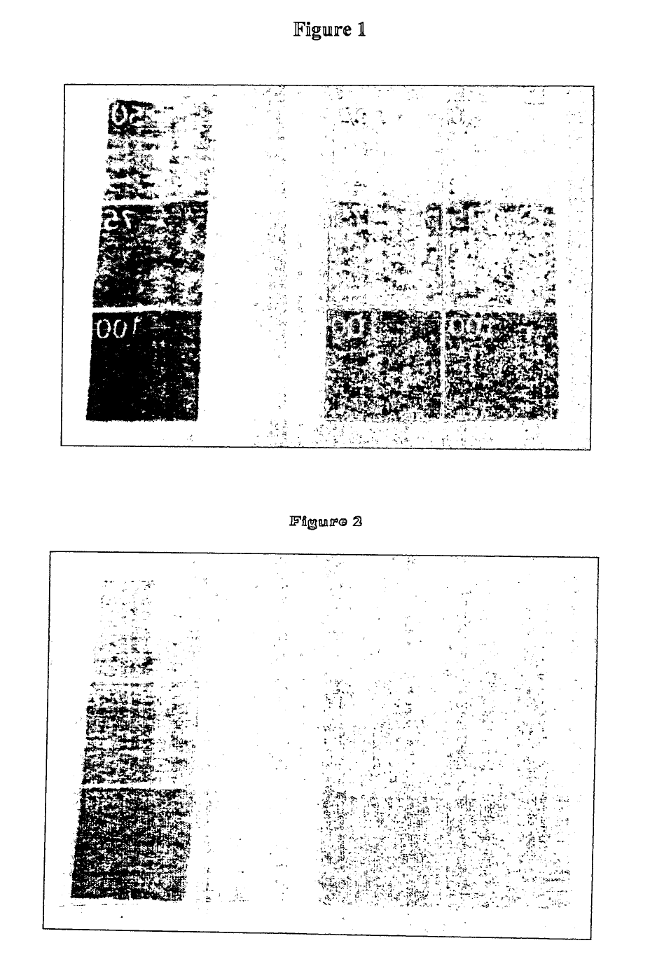

FIG. 1 presents the rear side of a white cotton piece onto which the image was printed using a first part ink composition containing an exemplary property (pH) sensitive agent namely a resin binder that settles at low pH, but without applying the second part namely the wetting composition, and FIG. 2 presents the rear side of the same cotton piece onto which the same image was printed using the same first part ink composition subsequent to contacting the surface of the substrate with the second part of the ink composition containing an exemplary property-adjusting agent, namely acetic acid as an organic acid for lowering the pH. As can be seen in FIG. 1, the inks penetrated the cotton fabric and left a very clear impression of the inverse image, however, as can be seen in FIG. 2, when the wetting composition comprising a pH-adjusting agent was applied, the inks comprising a property-sensitive agent hardly penetrated the fabric and the only a faint impression of the image is visible.

These results clearly demonstrate the advantageous effect of the process using a two-part ink composition wherein the second part is a wetting composition, in combination with a property (pH)-adjusting agent that reacts with a property (pH)-sensitive agent, by showing how a high-resolution image in obtained at higher optical density per each basic color, as compared to an identical image printed without the wetting composition.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. An ink composition suitable for printing an image on a substrate comprising a carrier, a colorant, an agent capable of chemically interacting with the substrate and a catalyst for promoting said interacting, the composition being substantially devoid of a polyol.

2. The ink composition of claim 1, wherein said substrate is selected from the group consisting of a textile fabric, a paper, a wood and a plastic.

3. The ink composition of claim 1, being characterized by Brookfield viscosity at room temperature of about 16.5 centipoises, surface tension of about 31 dynes per centimeter and maximal particle size lower than 1 micron.

4. The ink composition of claim 1, wherein said carrier is selected from the group consisting of an aqueous carrier and a non-aqueous carrier.

5. The ink composition of claim 1, wherein said agent capable of chemically interacting with the surface of the substrate is a cross-linking agent.

6. The ink composition of claim 1, wherein said catalyst is an acid.

7. An ink composition suitable for printing an image on a substrate, comprising a carrier, a colorant, a polyol, an agent capable of chemically interacting with the substrate and a catalyst for promoting said interacting, with the proviso that said agent capable of chemically interacting with the substrate is not an aldehyde-based cross-linking agent.

8. The ink composition of claim 7, wherein said substrate is selected from the group consisting of a textile fabric, a paper, a wood and a plastic.

9. The ink composition of claim 7, being characterized by Brookfield viscosity at room temperature of about 16.5 centipoises, surface tension of about 31 dynes per centimeter and maximal particle size lower than 1 micron.

10. The ink composition of claim 7, wherein said carrier is selected from the group consisting of an aqueous carrier and a non-aqueous carrier.

11. The ink composition of claim 7, wherein said polyol is selected from the group consisting of a polyester polyol, a polyether polyol, a urethane polyol, a polyether, a polyester acrylate, an acrylic polyol, a urethane acrylic polyol, a polyester urethane triol resin, a polyvinyl butyral, a polyvinyl chloride acrylate and an oxidized castor oil.

12. The ink composition of claim 7, wherein said agent capable of chemically interacting with the surface of the substrate is a cross-linking agent.

13. The ink composition of claim 7, wherein said catalyst is an acid.

14. An ink composition suitable for printing an image on a substrate, comprising a carrier, a colorant, a polyol, an agent capable of chemically interacting with the substrate and a catalyst for promoting said interacting, wherein a concentration of said polyol ranges from about 11 weight percentages to about 20 weight percentages of the total weight of the ink composition.

15. The ink composition of claim 14, wherein said substrate is selected from the group consisting of a textile fabric, a paper, a wood and a plastic.

16. The ink composition of claim 14, being characterized by Brookfield viscosity at room temperature of about 16.5 centipoises, surface tension of about 31 dynes per centimeter and maximal particle size lower than 1 micron.

17. The ink composition of claim 14, wherein said carrier is selected from the group consisting of an aqueous carrier and a non-aqueous carrier.

18. The ink composition of claim 14, wherein said polyol is selected from the group consisting of a polyester polyol, a polyether polyol, a urethane polyol, a polyether, a polyester acrylate, an acrylic polyol, a urethane acrylic polyol, a polyester urethane triol resin, a polyvinyl butyral, a polyvinyl chloride acrylate and an oxidized castor oil.

19. The ink composition of claim 14, wherein said agent capable of chemically interacting with the surface of the substrate is a cross-linking agent.

20. The ink composition of claim 14, wherein said catalyst is an acid.

21. An ink composition suitable for printing an image on a substrate comprising a first part and a second part, wherein one of said first part or said second part comprises a property adjusting agent and the other of said first part or said second part, which does not comprise a property adjusting agent, comprises a property sensitive agent, and further wherein said first part comprises a carrier, a colorant and a polyol, and wherein said second part comprises a wetting composition, said wetting composition being capable of interfering with the engagement of the ink composition with at least one binding site on the surface of said substrate.

22. The ink composition of claim 21, wherein said substrate is selected from the group consisting of a textile fabric, a paper, a wood and a plastic.

23. The ink composition of claim 21, wherein said carrier is selected from the group consisting of an aqueous carrier and a non-aqueous carrier.

24. The ink composition of claim 21, wherein said polyol is selected from the group consisting of a polyester polyol, a polyether polyol, a urethane polyol, a polyether, a polyester acrylate, an acrylic polyol, a urethane acrylic polyol, a polyester urethane triol resin, a polyvinyl butyral, a polyvinyl chloride acrylate and an oxidized castor oil.

25. The ink composition of claim 21, wherein said property-adjusting agent effects a chemical and/or physical change in said property-sensitive agent upon contacting said first part and said second part, and thereby effects a chemical and/or physical change in the ink composition.

26. The ink composition of claim 25, wherein said property is a chemical and/or physical property selected from the group consisting of acidity (pH), ionic strength, solubility, hydrophobicity and electric charge.

27. The ink composition of claim 25, wherein said property-adjusting agent is selected from the group consisting of an acid, a base, a salt, a charged polymer, an oxidizing agent, a reducing agent, a radical-producing agent and a cross-linking agent.

28. The ink composition of claim 26, wherein said property is acidity.

29. The ink composition of claim 28, wherein said property-adjusting agent is an organic acid.

30. The ink composition of claim 25, wherein said property-sensitive agent is selected from the group consisting of an adhesion promoting agent, a dispersing agent, a viscosity modifying agent, a thickener agent, a surface tension modifying agent, a surface active agent, a surfactant and a softener.

31. The ink composition of claim 25, wherein of said property-sensitive agent is an agent capable of chemically interacting with the surface and said property-adjusting agent is a catalyst.

32. The ink composition of claim 21, wherein said second part of the ink composition is characterized by a surface tension lower than a surface tension of the first part of the ink composition.

33. The ink composition of claim 21, wherein said wetting composition comprises at least one solvent selected from the group consisting of water and an organic solvent.

34. The ink composition of claim 33, wherein said second part of the ink composition further comprises at least one agent selected from the group consisting of an amine stabilizer, an alcohol stabilizer, a non-reactive agent, a softener/plasticizer, a surface active agent, a surface tension modifying agent, a viscosity modifying agent, a thickener agent and any combination thereof.

35. A process of printing an image on a substrate, the process comprising:
applying the ink composition of claim 1 on the surface, so as to form the image on the substrate.

36. A process of printing an image on a substrate, the process comprising:
applying the ink composition of claim 7 on the surface, so as to form the image on the substrate.

37. A process of printing an image on a substrate, the process comprising:
applying the ink composition of claim 14 on the surface, so as to form the image on the substrate.

38. A process of printing an image on a substrate, the process comprising:
providing the ink composition of claim 21;
contacting at least a portion of the surface of the substrate with said second part of said ink composition, so as to provide a wet portion of said surface; and
applying said first part of said ink composition on said wet portion of said surface, so as to form the image on the substrate.

39. The process of claim 38, wherein said portion is a pre-determined portion of the surface.

40. The process of claim 38, wherein a density of said second part of said composition in said wet portion of the surface ranges from about 0.01 gram per 1 cm² to about 2 grams per 1 cm² of said wet portion of the surface.

41. A substrate having an image printed on a surface thereon, prepared by the process of claim 35.

42. A substrate having an image printed on a surface thereon, prepared by the process of claim 36.

43. A substrate having an image printed on a surface thereon, prepared by the process of claim 37.

44. A substrate having an image printed on a surface thereon, prepared by the process of claim 38.
